(19) United States
(12) Patent Application Publication
(10) Pub. No.: US 2025/0206666 A1
(43) Pub. Date: Jun. 26, 2025

(54) COAL-DERIVED CARBON-BASED STRUCTURAL UNITS AND METHODS FABRICATION

(71) Applicant: UNIVERSITY OF WYOMING, Laramie, WY (US)

(72) Inventors: Kam weng NG, Laramie, WY (US); Md Tarik HOSSAIN, Laramie, WY (US); Chooi Kim LAU, Laramie, WY (US)

(21) Appl. No.: 18/831,383

(22) PCT Filed: Jun. 23, 2023
(86) PCT No.: PCT/US2023/026120

§ 371 Date: Dec. 24, 2024

Related U.S. Application Data
(60) Provisional application No. 63/355,426, filed on Jun. 24, 2022.

(51) Int. Cl. C04B 26/26; C04B 18/06; C04B 26/00; C04B 40/00

(52) U.S. Cl. CPC C04B 26/26; C04B 18/065; C04B 26/006; C04B 40/0071; C04B 40/0082; C04B 2201/20; C04B 2201/32; C04B 2201/52

(57) ABSTRACT

Embodiments of the present disclosure related carbon-based structural unit (CSU). The CSUs include a cured composition. The cured composition includes about 1% to about 80% pyrolysis char (PC), about 0.1% to about 35% coal deposits, extracts, and residual tar (CDER) materials, and about 0% to about 99% pitch material. The CDER material includes a tetralin insoluble (TI), a deposit (De), a distillation residue (DR), and a residue (Re). A method of making a composition includes extracting a coal extraction residue (CER) from coal; fabricating pyrolysis char (PC) and a coal deposits, extracts, and residual tar (CDER) material from the CER; sieving and milling the PC into milled PC; and mixing the pyrolysis char (PC) and the CDER material to form a composition.

### GOVERNMENT RIGHTS

This application claims was made with government support under DE-FE0031996 awarded by the Department of Energy. The government has certain rights in the invention.

### BACKGROUND

### Field

Embodiments of the present disclosure generally relate to compositions of carbon-based structural units (CSUs) and methods of forming CSUs using the composition.

### Description of Related Art

Coal currently serves an important role as an energy source but the increasing demand for renewable energy has reduced the production and consumption of coal in the United States of America (USA). Coal is carbon-rich, and its use in energy generation may affect atmospheric CO₂ levels. The air pollution and global environmental issues associated with the combustion of coal have limited the continuous application of coal in energy production. Specifically, according to the Bureau of Safety and Environmental Enforcement (BSEE), global warming results from various greenhouse gas emissions is partly due to fossil fuel burning, such as the combustion of coal. Therefore, several studies are being conducted to create new non-energy and fuel opportunities for Wyoming coal.

Wyoming serves as one of the major producers of coal in the USA. Wyoming Powder River Basin (PRB) coal plays an important role in the Wyoming energy industry. However, renewable energy is slowly replacing the coal industry, causing the market price of coal to drop. Thus, to attract new investment through technological innovation and support coal mine operations, environmentally friendly methods to create new diversified coal products are needed. One concern is characterizing the eco-efficiency of char products, which includes life-cycle metrics. In addition, the worldwide demand for structural building materials is rising. Moreover, environmentally friendly building materials are desirable for enabling “green” building projects. Therefore, there is a need for improved carbon-based structural units (CSUs) derived from coal and methods of fabrication thereof.

### SUMMARY

In one embodiment, a composition is disclosed. The composition includes about 1% to about 80% pyrolysis char (PC), about 0.1% to about 35% coal deposits, extracts, and residual tar (CDER) materials, and about 0% to about 99% pitch material.

In another embodiment, carbon-based structural unit (CSU) is disclosed. The CSU includes a cured composition. The cured composition includes about 1% to about 80% pyrolysis char (PC), about 0.1% to about 35% coal deposits, extracts, and residual tar (CDER) materials, and about 0% to about 99% pitch material.

In yet another embodiment, a method includes extracting a coal extraction residue (CER) from coal; fabricating pyrolysis char (PC) and a coal deposits, extracts, and residual tar (CDER) material from the CER; sieving and milling the PC into milled PC; and mixing the pyrolysis char (PC) and the CDER material to form a composition.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a flow diagram of a method of forming carbon-based structural units (CSUs), according to embodiments.

FIG. 2 is a graph illustrating the particle size analysis of the PC, according to embodiments.

FIG. 3 is a graph illustrating the Brunauer-Emmett-Teller (BET) analysis of the PC, according to embodiments.

FIG. 4 is a graph illustrating the x-ray powder diffraction (XRD) analysis of the PC, according to embodiments.

FIG. 5 is a graph illustrating the Fourier Transform Infrared (FTIR) analysis of the PC, according to embodiments.

FIG. 6 is an SEM micrograph illustrating the PC, according to embodiments.

FIG. 7 is a graph illustrating the FTIR analysis of coal deposits, extracts, and residual tar (CDER) materials, according to embodiments.

FIG. 8 is a graph illustrating the FTIR analysis of CDER materials and other commercial pitch materials, according to embodiments.

FIG. 9 is a graph illustrating the XRD analysis of the CDER materials, according to embodiments.

FIG. 10 is a graph illustrating the thermogravimetric analysis (TGA) of mesophase pitch from coal (MP (coal)), according to embodiments.

FIG. 11 is a graph illustrating the TGA of coal tar pitch (CTP), according to embodiments.

FIG. 12 is a graph illustrating the TGA of deposit (Dc), according to embodiments.

FIG. 13 is a graph illustrating the TGA of toluene insoluble (TI), according to embodiments.

FIG. 14 is a graph illustrating the TGA of distillation residue (DR), according to embodiments.

FIG. 15 s a graph illustrating the proton nuclear magnetic resonance (¹H NMR) of CDER materials and other commercial pitch materials, according to embodiments.

FIG. 16 is a graph illustrating the carbon-13 nuclear magnetic resonance (¹³C NMR) of CDER materials and other commercial pitch materials, according to embodiments.

FIG. 17 is a graph illustrating the FTIR analysis of De, MP (coal), and heat treated De, according to embodiments.

FIG. 18 is a graph illustrating the FTIR analysis of heat treated De, according to embodiments.

FIG. 19 is a graph illustrating the XRD analysis of the heat treated De, according to embodiments.

FIG. 20 is a graph illustrating the FTIR analysis of TI, MP (coal), and heat treated TI and other commercial pitch materials, according to embodiments.

FIG. 21 is a graph illustrating the FTIR analysis of heat treated TI, according to embodiments.

FIG. 22 is a graph illustrating the XRD analysis of the heat treated TI, according to embodiments.

FIG. 23 is a graph illustrating the XRD analysis of CDER materials, heat treated CDER materials, and other commercial pitch materials, according to embodiments.

FIG. 24 is a graph illustrating the TGA proximate analysis of De, according to embodiments.

FIG. 25 is a graph illustrating the TGA proximate analysis of De heat-treated at 410° C., according to embodiments.

FIG. 26 is a graph illustrating the TGA proximate analysis of De heat-treated at 430° C., according to embodiments.

FIG. 27 is a graph illustrating the TGA proximate analysis of De heat-treated at 450° C., according to embodiments.

FIG. 28 is a graph illustrating the TGA proximate analysis of TI, according to embodiments.

FIG. 29 is a graph illustrating the TGA proximate analysis of TI heat-treated at 410° C., according to embodiments.

FIG. 30 is a graph illustrating the TGA proximate analysis of TI heat-treated at 430° C., according to embodiments.

FIG. 31 is a graph illustrating the TGA proximate analysis of TI heat-treated at 450° C., according to embodiments.

FIG. 32 is a graph illustrating the TGA of P&H treated De, according to embodiments.

FIG. 33 is a graph illustrating the TGA of P&H treated TI, according to embodiments.

FIG. 34 is a graph illustrating the FTIR analysis of MP (coal) and De, according to embodiments.

FIG. 35 is a graph illustrating the FTIR analysis of MP (coal) and TI, according to embodiments.

FIG. 36 is a graph illustrating the XRD analysis of the De, heat-treated De, and P&H treated De, according to embodiments.

FIG. 37 is a graph illustrating the XRD analysis of the TI, heat-treated TI, and P&H treated TI, according to embodiments.

FIG. 38 is a graph illustrating the XRD analysis of the De, heat-treated De, P&H treated De, TI, heat-treated TI, P&H treated TI, and MP (coal), according to embodiments.

FIG. 39 is a graph of the TGA of P &H treated De, according to embodiments.

FIG. 40 is a graph of the TGA of P&H treated TI, according to embodiments.

FIG. 41 is a graph illustrating the compressive strength of CSUs varied by carbonization temperature, according to embodiments.

FIG. 42 is a graph illustrating the thermal conductivity of CSUs varied by carbonization temperature, according to embodiments.

FIG. 43A is a graph illustrating the oxidation process for the CDER material CSUs, according to embodiments.

FIG. 43B is a graph illustrating the carbonization process for the CDER material CSUs, according to embodiments.

FIG. 44A is a graph illustrating the stress-strain relationship of the TI+PC CSU, according to embodiments.

FIG. 44B is a graph illustrating the stress-strain relationship of the De430+PC CSU, according to embodiments.

FIG. 44C is a graph illustrating the stress-strain relationship of the TI430+PC CSU, according to embodiments.

FIG. 44D is a graph illustrating the stress-strain relationship of the De+MP+PC CSU, according to embodiments.

FIG. 44E is a graph illustrating the stress-strain relationship of the TI+MP+PC CSU, according to embodiments.

FIG. 44F is a graph illustrating the stress-strain relationship of the De430+MP+PC CSU, according to embodiments.

FIG. 44G is a graph illustrating the stress-strain relationship of the De450+MP+PC CSU, according to embodiments.

FIG. 44H is a graph illustrating the stress-strain relationship of the TI450+MP+PC CSU, according to embodiments.

FIG. 45 is a graph illustrating the compressive strength of the CDER CSUs, according to embodiments.

FIG. 46A is a graph illustrating the stress-strain curve of the DE_{P&H}+MP+PC CSU, according to embodiments.

FIG. 46B is a graph illustrating the stress-strain curve of the TI_{P&H}+MP+PC CSU, according to embodiments.

FIG. 47 is a graph illustrating the compressive strength the increased CDER material content CSUs, according to embodiments.

FIG. 48A is a graph illustrating the stress-strain curve of the first De-CSU, according to embodiments.

FIG. 48B is a graph illustrating the stress-strain curve of the second De-CSU, according to embodiments.

FIG. 48C is a graph illustrating the stress-strain curve of the first TI-CSU, according to embodiments.

FIG. 48D is a graph illustrating the stress-strain curve of the second TI-CSU, according to embodiments.

FIG. 49A is a graph illustrating the flexural strength of a CSU sample 1, according to embodiments.

FIG. 49B is a graph illustrating the flexural strength of a CSU sample 2, according to embodiments.

FIG. 49C is a graph illustrating the flexural strength of a CSU sample 3, according to embodiments.

FIG. 50 is a graph illustrating the modulus of rupture for CSU and concrete, according to embodiments.

FIG. 51A is a graph illustrating the load v. deformation curve of CSU sample 4, according to embodiments.

FIG. 51B is a graph illustrating the load v. deformation curve of CSU sample 6, according to embodiments.

FIG. 52 is a graph illustrating the compressive strength of CSU and concrete, according to embodiments.

FIG. 53 is a graph illustrating the Raman shift of MP (coal) and CTP, according to embodiments.

FIG. 54A is a graph illustrating the stress/strain curve of a first CSU sample, according to embodiments.

FIG. 54B is a graph illustrating the stress/strain curve of a second CSU sample, according to embodiments.

FIG. 55 is a graph illustrating the compressive strength of a first CSU sample and the second CSU sample, according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to compositions of carbon-based structural units (CSUs) and methods of forming CSUs using the composition. In one embodiment, a composition is described herein. In another embodiment, a CSU including a cured composition is described herein. In another embodiment, a method of forming a CSU from the composition is described herein.

The inventors have found new and improved methods for fabricating CSUs from pyrolysis char (PC) and coal deposits, extracts, and residual tar (CDER) materials. Briefly, raw coal is thermo-chemically converted to produce PC and CDER materials. The resulting PC and CDER material are then converted to CSUs.

The desire for environmentally-friendly materials, energy savings, and reduced energy consumption in building materials can be addressed by the building materials described herein. Building materials made with PC and CDER material have reduced density, increased strength, reduced thermal conductivity, and increased insulative properties when compared to conventional materials, such as clay bricks. These materials, through recycling/reuse and decreasing the amount of energy usage in fabrication, further lessens the environmental impact of the CSUs.

The use of headings is for purposes of convenience and does not limit the scope of the present disclosure. Embodiments described herein can be combined with other embodiments.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

### Compositions

Embodiments described herein generally relate to a composition and methods of forming a composition formed using pyrolysis char (PC) and coal deposits, extracts, and residual tar (CDER) materials. The composition may be used to form carbon-based structural units (CSUs).

The CSUs include PC, CDER materials. In some embodiments, the CSUs may include pitch materials. The CSUs include about 1% to about 80% PC, about 0.1% to about 35% CDER material, and about 0% to about 99% pitch material by weight. The CDER materials and pitch materials acts as a binder.

PC is a solid residue from a pyrolysis process of coal. The PC is pyrolyzed between about 600° C. and about 900° C. The grain size of the PC is about 0.05 mm to about 1.0 mm, such as about 0.25 mm to about 0.5 mm. The porosity of the PC is about 0.01% to about 0.025%. The average pore size of the PC is about 1 nm to about 2 nm. The specific surface area of the PC is about 200 m²/g to about 300 m²/g.

The CDER materials include tetralin insoluble (TI), deposit (De), distillation residue (DR), and residue (Re). The softening point for De is between about 200° C. and about 300° C. The softening point for TI is between about 200° C. and about 300° C. The softening point for DR is between about 80° C. and about 150° C. The pitch materials may include mesophase pitch from coal (MP (coal)), mesophase pitch from naphthalene (MP (naphthalene)), or coal tar pitch (CTP).

The CSUs have a compressive strength of about 10 MPa to about 120 MPa. The CSUs have a flexural modulus of rupture between about 3 MPa and about 6 MPa. The average modulus of rupture of concrete is 3.01 MPa, thus, the CSU is about 50% higher than concrete. The average split tensile strength of the CSU is about 4 MPa to about 6 MPa. The average split tensile strength of concrete is about 2.58 MPa, thus, the CSU is about 235% higher than the concrete.

The average density of the CSUs is from about 0.5 g/cm³ 1.5 g/cm³. Conventional clay bricks have a density of about 2.18 g/cm³. By decreasing the density of the CSUs as compared to conventional clay bricks, the monetary cost and environmental cost of transporting building materials may be decreased.

The CSUs have a thermal conductivity from about 0.1 W/m·K to about 0.5 W/m·K. Conventional clay bricks typically have a thermal conductivity value between about 0.5 W/m·K and about 1.0 W/m·K. A low thermal conductivity value indicates an increased ability to provide insulation properties. The CSUs have a lower thermal conductivity than conventional clay bricks, thus making them preferable in terms of insulation qualities in construction projects.

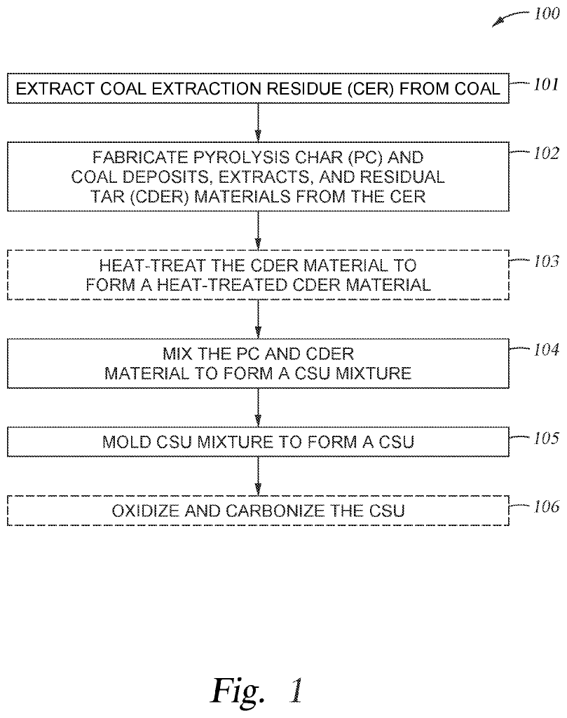

FIG. 1 illustrates a flow diagram of a method 100 of forming carbon-based structural units (CSUs). At operation 101, coal extraction residue (CER) is extracted from coal.

At operation 102, a pyrolysis char (PC) and a coal deposits, extracts, and residual tar (CDER) material are obtained from the CER. The CDER may be a solvent extracted from the coal. The solvent extraction process may use tetralin as the solvent for coal refining. In some embodiments, one or more reactors are loaded with the coal. The reactors are heated using an oven at a temperature of about 500° C. to 1000° C. A high-performance liquid chromatography (HPLC) pump is primed with tetralin and the system is pressurized to about 200 psi to about 300 psi with argon. A specific rate of tetralin is flowed through the reactors when the temperatures in the extract lines rise above about 500° C. to 1000° C. The tetralin flow is stopped after about 2 hours to about 6 hours under the temperature and the reactors start to cool down. Argon is used to remove the tetralin from the extraction lines. The argon is blown out of the extract lines to remove the remaining tetralin after the temperature of the extraction lines drops to about 100° C. to about 150° C. The residue (Re) remaining in the reactors is collected.

The Re is washed with toluene at room temperature and the remaining tetralin is removed, leaving tetralin insoluble (TI) material. The TI material is dried in a vacuum oven. Distilled residue (DR) is separated from the remaining tetralin. In one embodiment, the DR is separated from tetralin using a rotary evaporator. The deposit (DE) dissolved in the acetone solution from the system wash is solidified. As a result, four solid products can be obtained by dissolving coal in tetralin at elevated temperature and pressure: (1) the residue of undissolved coal (Re); (2) deposit (De), which is the least soluble dissolved material; (3) tetralin insoluble (TI), which precipitates at room temperature; and (4) distillation residue (DR), which is soluble at room temperature. A CDER material includes the four solid products Re, De, TI, and DR. In one embodiment, the PC and CDER material are manufactured at temperatures between about 700° C. and about 900° C.

At optional operation 103, the CDER material is heat-treated to form a heat-treated CDER. Heat treating the CDER materials may increase the content of heavy molecular weight components, improving the ability of CDER materials to act as a binder material. The heat-treatment occurs between 400° C. and 500° C. Heat-treating the CDER materials may cause volatilization of low molecular mass constituents of the pitch and polymerization and condensation reactions of the hydrocarbons. In addition, hydrogenation, fragmentation, alkylation or dehydrogenative polymerization may occur during heat-treatment. Thermal cracking of the aliphatic side group at the a-position in the aromatic molecules may result in the free radicals. These free aromatic radicals may react with each other to produce aryl-aryl linkages and then build up the polyaromatic molecules to form a carbonaceous mesophase.

In some embodiments, the CDER material is pressure heat-treated to form pressure heat-treated CDER (P&H treated CDER). P&H treated CDER materials may increase the aromatic index and the content of heavy molecular weight components in the CDER materials. The treatment may be conducted using an electrical strip reactor. During the treatment, an applied pressure of about 2 MPa to about 6 MPa is maintained at about 400° C. to about 500° C. for about 3 hours to about 10 hours in nitrogen environment. The heating rate is about 2.5° C./min to about 7.5° C./min. After the completion of heat treatment, the heater is turned off and left for about 6 hours to about 18 hours before cooling to room temperature. The CDER materials melt at this temperature, and volatile materials evaporate. After cooling, they form an integrated part that is ground with marble mortar and pestle to make fine particles.

In some embodiments, the PC is sieved and milled to form milled PC. In one embodiment, the PC is milled using a ball mill. In another embodiment, the PC is mixed with binders and milled to form the milled PC. The milled PC may be sieved and dried. The milled PC may have a diameter of less than about 35 μm. A ball mill machine may be used to grind the PC to obtain particle sizes less than 40 μm (e.g., using a #400 sieve). Stainless steel balls, about 10 mm and 20 mm in diameter, are placed inside a drum during the grinding process. The ball milling may be conducted for 20 hours to about 28 hours at a speed of 25 rpm to about 75 rpm in one directional rotation. Greater than 99% of the char powder passed through the sieve.

At operation 104, the PC and CDER material are mixed to form a CSU mixture. The PC and CDER materials are mixed at a ratio of about 1:1 to about 1:4 CDER material to PC. In some embodiments, The PC and CDER material are mixed with a pitch material to form the CSU mixture. The CSU mixture includes about 1% to about 80% PC, about 0.1% to about 35% CDER material, and about 0% to about 99% pitch material by weight. In some embodiments, manually ground pith material, i.e., mesophase pitch, is ball-milled with about 600 gm of this PC to mix evenly for 20 hours to about 28 hours at a speed of 25 rpm to about 75 rpm. After that, the mixture is oven-dried at a temperature of 150° C. for 24 hours before storing it in an air-tight container.

At operation 105, the CSU mixture is molded to form CSUs. In some embodiments, the mixture is molded under pressure. The CSU mixture may be molded under an applied pressure of about 50 MPa to about 500 MPa. A 50-ton capacity pressing equipment may be used to apply the pressure on the CSU mixture.

At optional operation 106, the CSUS are oxidized and carbonized. In an oxidation stabilization process, the CSU is first heated to about 200° C. to about 300° C. in an air atmosphere at a rate of 0.25° C./min to about 1.5° C./min and held at this temperature for 12 hour to about 20 hours. The oxidation stabilization process enables volatile contents in the mesophase pitch to be released in a low manner to mitigate the foaming risk. In a carbonization process, the CSU is heated to a higher temperature, about 600° C. to about 1000° C., at a rate of about 1.5° C./min to about 4.5° C./min and held at this temperature for about 0.5 hours to about 3 hours. The carbonization process may occur in an argon atmosphere.

### Uses

Embodiments of the present disclosure also generally relate to uses of the compositions described herein. Compositions described herein can also be used for various applications.

Illustrative, but non-limiting, applications include concrete masonry units such as cinder blocks, breezeblocks, hollow blocks, concrete blocks, construction blocks, Besser blocks, clinker blocks, among other concrete masonry units.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### EXAMPLES

### Test Methods

The Brunauer-Emmett-Teller (BET) analysis is performed using QUADRASORB evo surface area and pore size analyzer. The BET analysis was performed using ASTM D6556.

The x-ray diffraction (XRD) analysis is performed using a Ragku Smartlab diffractometer with a copper (Cu) potassium (Ka) source, operated at 44 kV and 44 mA with an angle of reflection of 2-theta (2θ) varied between 10° and 90°.

The Fourier Transform Infrared Spectroscopy (FTIR) is measured using a Nicolet iS50 FTIR spectrometer from Thermo Scientific.

The Scanning Electron Microscopy (SEM) is measured using FEI Quanta 250 Conventional SEM.

The thermogravimetric analysis (TGA) is performed using TGA 5500 discovery series of TA instruments.

The nuclear magnetic resonance (NMR) is performed using Bruker Avance III spectrometer.

Proximate analysis is performed using ASTM D7482.

Ultimate analysis is performed using ASTM D4239 and D5373.

The compressive strength of the CSUs is measured using a Zwick/Roell Z020 compression testing machine. The compressive strength of the CSUs is measured using ASTM C39.

The density is calculated from the measured sample geometry and mass after carbonization.

Thermal conductivity is measured using Hot Disk TPS 1500. The thermal conductivity of the CSUs was measured using ISO 22007-2.

The flexural strength of the CSUs is measured using a Zwick/Roell Z020 compression testing machine. The flexural strength of the CSUs is measured using ASTM C78.

The split tensile (Brazilian) tests are conducted using Zwick/Roell Z020 compression testing machine through a force-controlled test. A 20-kN load cell with an extensometer is used with a loading rate of 200 N/min. The split tensile (Brazilian) tests are conducted using ASTM D3967.

### EXPERIMENTAL

Table 1 shows a summary of the chemical composition of a pyrolysis char (PC). The PC was pyrolyzed at about 850° C., with a yield rate of about 46.3%. The yield rate is the ratio of the total amount of PC obtained to the total amount of raw coal used. The dominant material in the PC is carbon, while the metal contents are low (e.g., less than 15 mg of metal per kg of PC; e.g., 15 ppm). The metal contents of the PC satisfy multiple standards, including: the European Union Restrictions of Hazardous Substances (RoHS) Direction (less than 1,000 ppm of arsenic, chromium, copper, lead, mercury, and selenium; less than 10,000 ppm for cadmium); the Federal Hazardous Substances Act (FHSA), C.F.R. Title 16, Part 1500.17 (limits lead content for household products to less than 600 ppm of the total weight); ASTM F693-17 (sets maximum value for surface coatings and substrates included as part of a toy for arsenic at less than 25 ppm, cadmium at less 75 ppm, chromium at less than 60 ppm, lead at less than 90 ppm, mercury at less than 60 ppm, and selenium at less than 500 ppm); and the Consumer Product Safety Act (CPSA), C.F.R. Title 16, Part 1303 (sets maximum lead content in paints and surface-coating materials for children's products and general consumer products at 90 ppm). Thus, the PC used to form the carbon-based structural units (CSUs) are demonstrated as safe for use in commercial building applications.

TABLE 1
Summary of Chemical Composition of PC.

| Category | Parameter | Amount |
|---|---|---|
| Major components | Ash (%) | 15.96 |
| | Volatile Matter (%) | 1.2 |
| | Fixed Carbon (%) | 79.87 |
| | Moisture (%) | 2.97 |
| Metal components | Arsenic (mg/kg) | 3 |
| | Cadmium (mg/kg) | Not detected |
| | Chromium (mg/kg) | 9 |
| | Copper (mg/kg) | 14 |
| | Lead (mg/kg) | 1 |
| | Mercury (mg/kg) | Not detected |
| | Selenium (mg/kg) | Not detected |

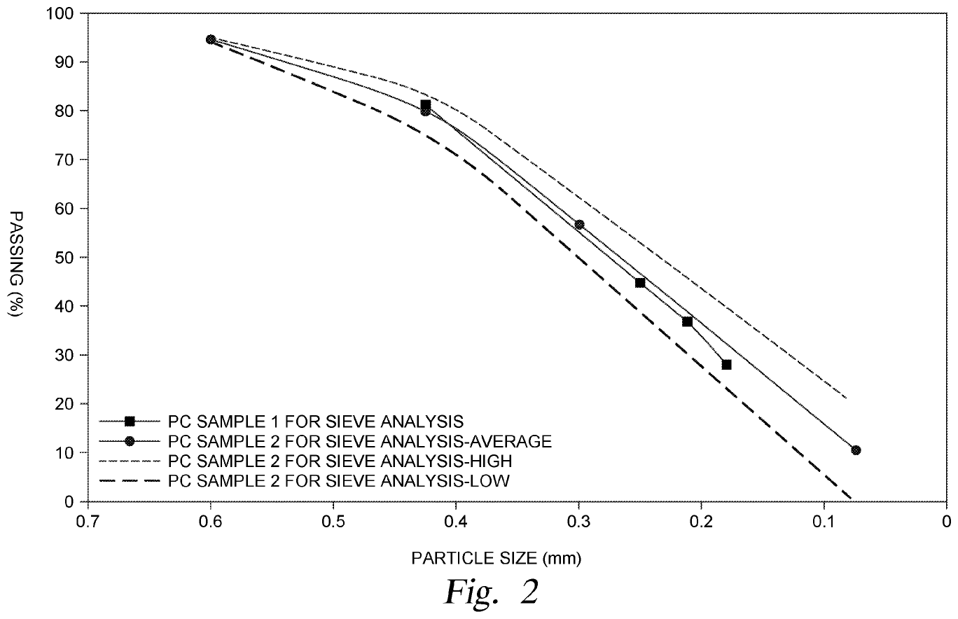

FIG. 2 is a graph illustrating the particle size analysis of the PC. FIG. 2 shows a PC sample 1 and PC sample 2 having similar size distribution. PC sample 2 shows a relatively narrow particle size distribution range. The sieve analysis verifies that the PC sample 1 and PC sample 2, as a feedstock for coal-derived building materials such as CSUs, possess the characteristics and grain size similar to a medium sand aggregates (about 0.25 mm diameter to about 0.5 mm diameter), according to the Wentworth grain size scale.

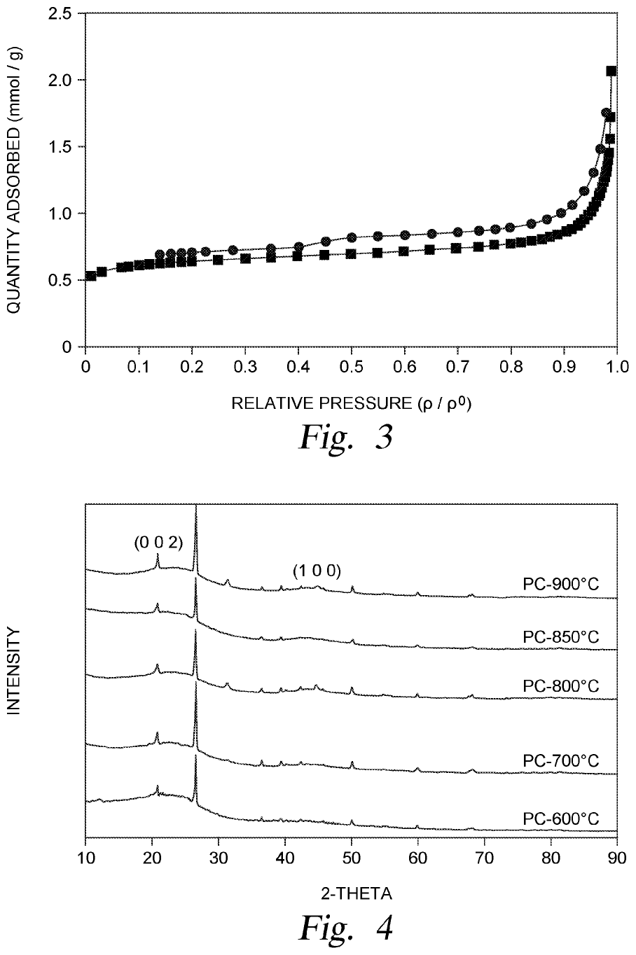

FIG. 3 is a graph illustrating the Brunauer-Emmett-Teller (BET) analysis of the PC. The BET analysis shows the nitrogen porosity analysis result of the PC. The PC had a specific surface area of about 262 m²/g and an average pore size of about 1.4 nm. The porosity of the PC with a particle size between about 0.3 mm and about 0.425 mm is about 18%.

FIG. 4 is a graph illustrating the x-ray powder diffraction (XRD) analysis of the PC. XRD is widely used in the determination of the crystallinity of carbonaceous material. The PC was pyrolyzed at 600° C., 700° C., 800° C., 850° C., and 900° C. and analyzed using XRD. An intensive broad peak (0 0 2), which corresponds with the graphitic basal plane, is observed at 2θ values between about 20° to about 30°. A broad peak (1 0 0) at about 43° corresponds with the graphitic crystalline features of PC, which presents increasing peak values with increasing pyrolysis temperatures from 600° C. to 900° C. This is due to the stable aromatic form of the carbon species in the PC, two sharp peaks at about 21° and about 26° demonstrate the presence of low percentage of inorganic silica in the PC.

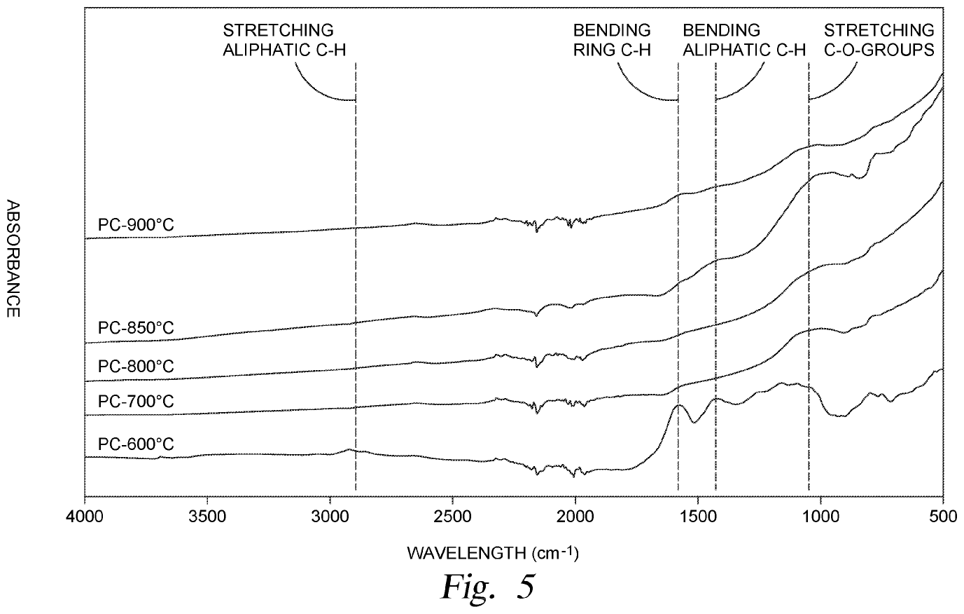

FIG. 5 is a graph illustrating the Fourier Transform Infrared (FTIR) analysis of the PC. The PC was pyrolyzed at 600° C., 700° C., 800° C., 850° C., and 900° C. and analyzed using FTIR. The decomposition and the evaporation of the organic matters during the pyrolysis of coal causes the disappearance of the vibrational bonds and reduction in the intensity of the bands. A wavenumber of around 2910 cm⁻¹ and 1430 cm⁻¹ correspond to the stretching aliphatic CH and bending aliphatic CH, respectively. The shapes of the FTIR characteristic curves demonstrate similar peak locations. The stretching aliphatic and bending aliphatic CH groups may weaken and disappear as the pyrolysis temperature of the PC is increased from 600° C. to 900° C. This is due to the decomposition of the organic matter, which turns the carbon into the graphitic-like carbon. The bending ring C—H bond decreases significantly when the PC is pyrolyzed at a temperature higher than 600° C. The PC across the pyrolysis temperatures maintained a significant number of stretching C—O groups, as seen at about wavenumber 1070 cm⁻¹.

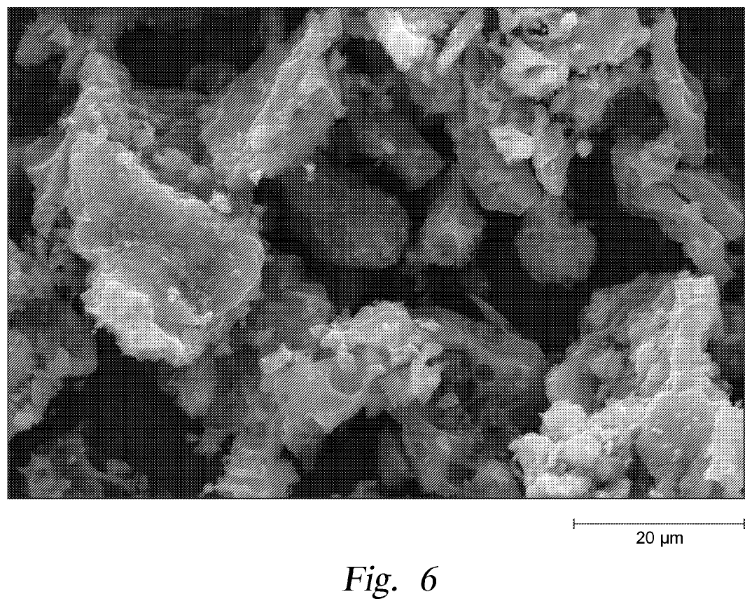

FIG. 6 is an SEM micrograph illustrating the PC. The PC is a smooth material with conchoidal fractures and bubbles that are generated during the pyrolysis process. These fractures and bubbles may leave a cavity in the PC and may increase the surface area.

Table 2 shows a summary of the composition of the CDER materials. The composition of the CDER materials is measured using ultimate analysis and proximate analysis. Solvent extraction in the coal extraction process occurs at low temperatures, such that the solvent extraction retains much of the oxygen in the coal. Carbon and oxygen are the dominant elements in the CDER materials.

TABLE 2
Summary of Composition of CDER Materials.

| | Ultimate analysis (w/w %) | | | | | Proximate analysis (w/w %) | | | |
|---|---|---|---|---|---|---|---|---|---|
| | | | O | | | | | Fixed | |
| Sample | N | C | (diff.) | H | S | Moisture | Volatile | carbon | Ash |
| Raw | 1.97 | 70.95 | 22.2 | 4.46 | 0.42 | 8.34 | 38.9 | 45.81 | 6.95 |
| coal | | | | | | | | | |
| De | 2.17 | 76.34 | 15.99 | 5.09 | 0.41 | 1.5 | 41.29 | 57.09 | 0.12 |
| DR | 1.56 | 82.5 | 7.89 | 7.56 | 0.49 | 1.41 | 82.28 | 16.15 | 0.16 |
| TI | 2.22 | 74.74 | 16.54 | 6.03 | 0.46 | 0.94 | 44.9 | 36.98 | 17.18 |
| Re | 1.49 | 72.69 | 21.18 | 4.26 | 0.38 | 1.4 | 32.96 | 50.27 | 15.37 |

The sulfur content within the CDER materials is the lowest of all the elemental components at less than 0.5 wt %. Low sulfur content is environmentally friendly due to the low emission of sulfur-related compounds during thermal treatment. The nitrogen content was relatively low, varying from 1.49 wt % to 2.22 wt % with an average value of 1.8 wt %. The oxygen content presents larger variations, from 7.89 wt. % to 21.18 wt %. The DR possesses the highest carbon content and the lowest oxygen content, followed by deposit (De), tetralin insoluble (TI), and residue (Re). Compared to raw coal, the four composites of CDER material show an increasing carbon content ratio attributing to the extraction process. According to the proximate analysis for CDER materials, DR has the lowest fixed carbon content and the highest volatile content. De has the highest fixed carbon content. TI shows the highest ash content. Re has the lowest volatile content and relatively higher fixed carbon and ash content.

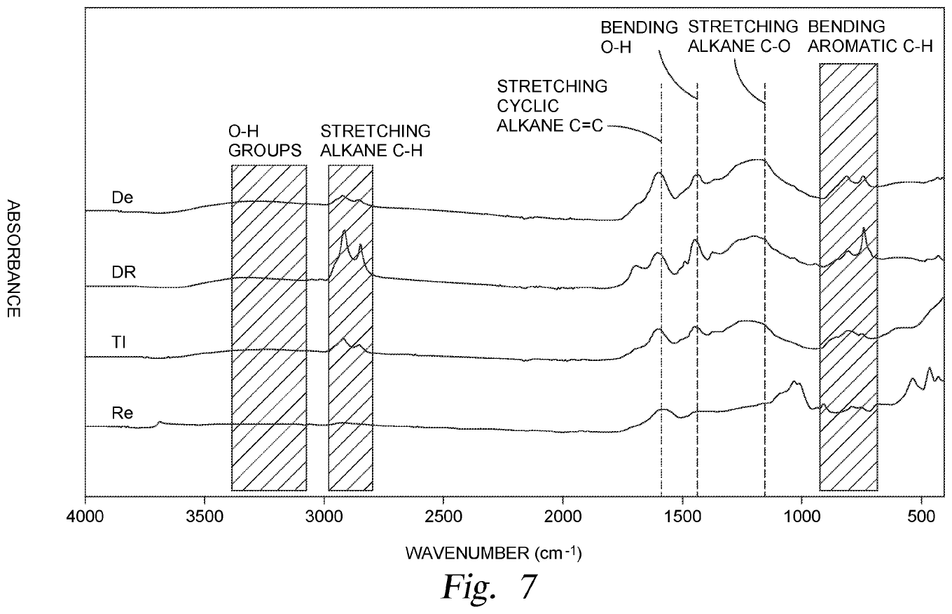

FIG. 7 is a graph illustrating the FTIR analysis of CDER materials. The CDER materials include De, DR, TI, and RE. FTIR bands ranging from about 3100 cm⁻¹ to 3300 cm⁻¹ indicate the presence of O—H groups within the CDER materials. The FTIR bands ranging from about 2800 cm⁻¹ to about 3000 cm⁻¹ indicate aliphatic and alicyclic CH₃, CH₂ and CH (e.g., the C—H stretching alkane). The peaks around about 1600 cm⁻¹ indicate C—C functional groups (e.g., the C═C stretching alkane). The peaks around about 1450 cm⁻¹ and around about 1200 cm⁻¹ indicate the presence of oxygen groups of O—H bending and C—O stretching alkane, respectively. Peaks observed in the range of about 700 cm⁻¹ to about 900 cm⁻¹ indicate aromatic, out-of-plane, and C—H bending (e.g., the C—H bending aromatic).

The DR shows more aliphatic C—H groups than other CDER materials. The TI and De samples have more oxygen-rich groups than the Re. In addition, the De, TI, and DR samples present relatively more aromatic groups than the Re.

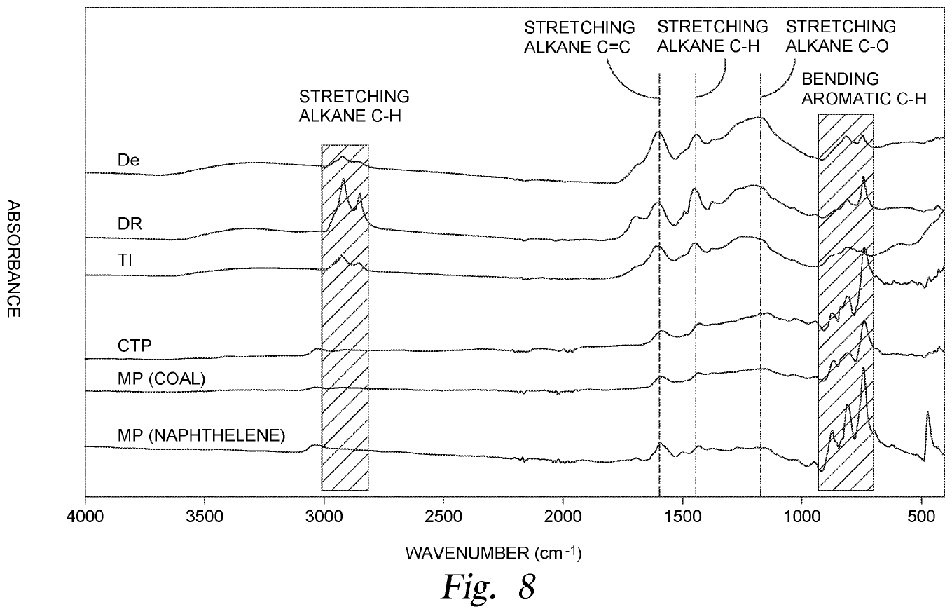

FIG. 8 is a graph illustrating the FTIR analysis of CDER materials and other commercial pitch materials. The CDER materials include De, TI, and DR. Other commercial pitch materials include mesophase pitch (MP) from coal, MP from naphthalene, and coal tar pitch (CTP). Other commercial pitch materials can be used as binders to develop carbon materials that exhibit high mechanical strength. Compared to the other commercial pitch materials, CDER materials have more aliphatic C—H stretching alkane (at about 2800 cm⁻¹ to about 3000 cm⁻¹ and 1450 cm⁻¹), C═C stretching alkane (at about 1600 cm⁻¹), and C—O stretching alkane (at about 1200 cm⁻¹) and less C—H bending aromatic (at about 700 cm⁻¹ to about 900 cm⁻¹). This indicates that thermal treatment of the CDER material may be beneficial in order to improve binder properties.

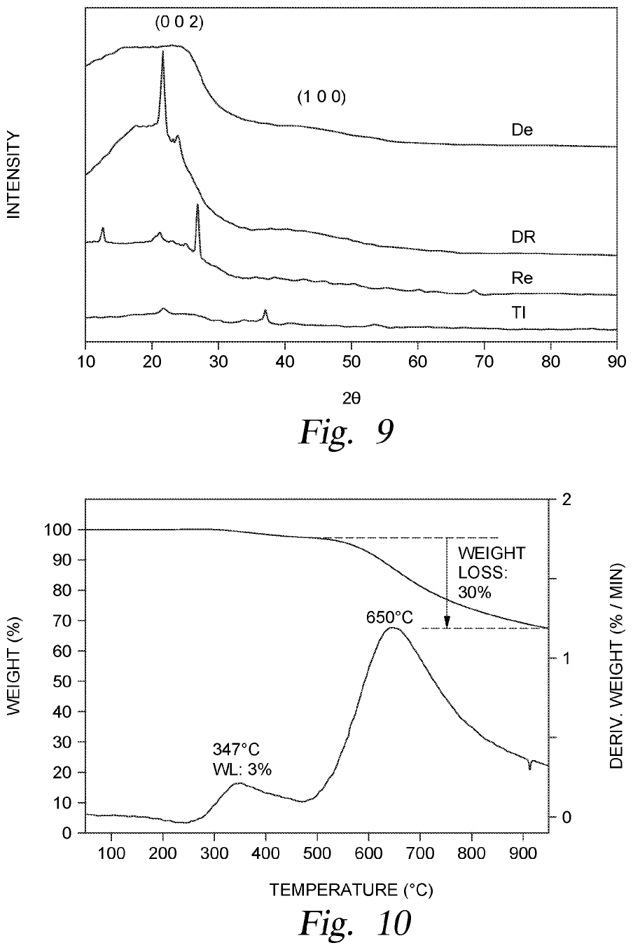

FIG. 9 is a graph illustrating the XRD analysis of the CDER materials. There is a stronger XRD diffraction peak at 2θ values of 20° to 40°, corresponding to the graphitic basal plane reflection. The weak broad peak at around 43° indicates crystal faces reflection. There is no significant crystallinity observed in any of the CDER materials.

The TGA indicates the temperature at which volatiles are liberated. The generation of volatiles during foaming generally acts as bubbling agent and creates a porous structure. TGA is conducted in a nitrogen atmosphere. Heating rate for MP (coal), deposit (De), and TI is set at about 10° C./min. The heating rate is set at 5° C./min for coal tar pitch (CTP) and DR, due to their lower softening points and higher content of volatile matters.

FIG. 10 is a graph illustrating the thermogravimetric analysis (TGA) of MP (coal). At up to 260° C., there is no significant weight loss for the MP (coal). The first large weight loss is observed at around 347° C., which may indicate volatilization or decomposition of low molecular weight pitch components. A major weight loss at around 650° C. may indicate the decomposition of a heavy pitch molecular weight component. Finally, a residual weight of ash at 950° C. is about 66%.

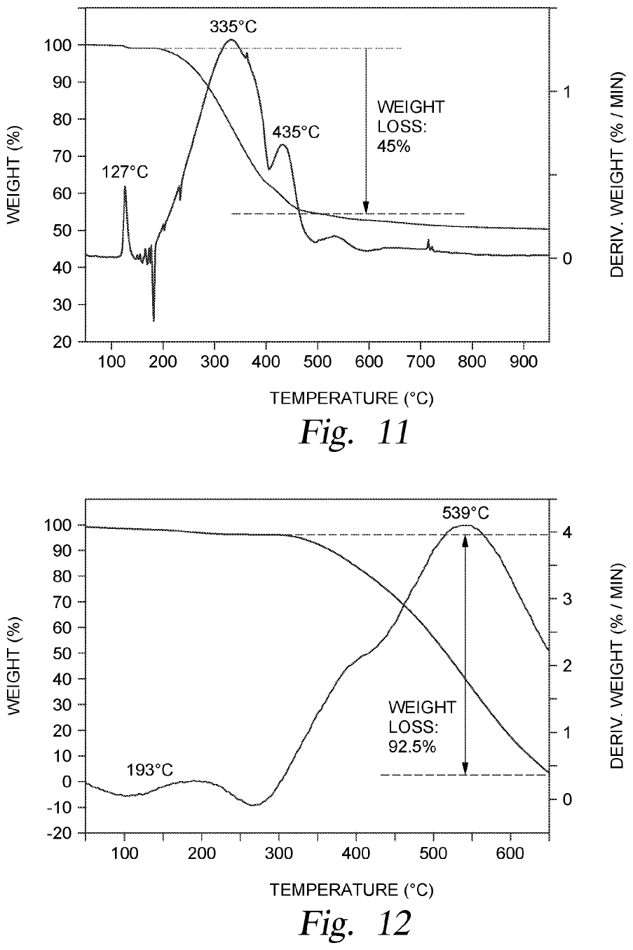

FIG. 11 is a graph illustrating the TGA of CTP. At up to 120° C., there is no significant weight loss for CTP. The first large weight loss is observed at around 127° C., which may indicate volatilization or decomposition of low molecular weight pitch components. A major weight loss at around 335° C. and 435° C. may indicate the decomposition of a heavy pitch molecular weight component. Finally, a residual weight of ash at 950° C. is about 50%.

FIG. 12 is a graph illustrating the TGA of De. At up to 120° C., there is no significant weight loss for De. There is only a slight weight loss up to 300° C., which may be due to the volatilization of low molecular weight pitch components and decomposition heavy molecular weight components. A major weight loss of 92.5% occurs around 335° C. and 435° C., which may indicate decomposition of the heavy molecular weight components. In this temperature range, the TGA fall steeply to give a residual weight of ash of around 3.5% at 650° C. The low pyrolysis yield of De show the relatively faster evolution of volatile decomposition that may be caused by the relatively high heating rate.

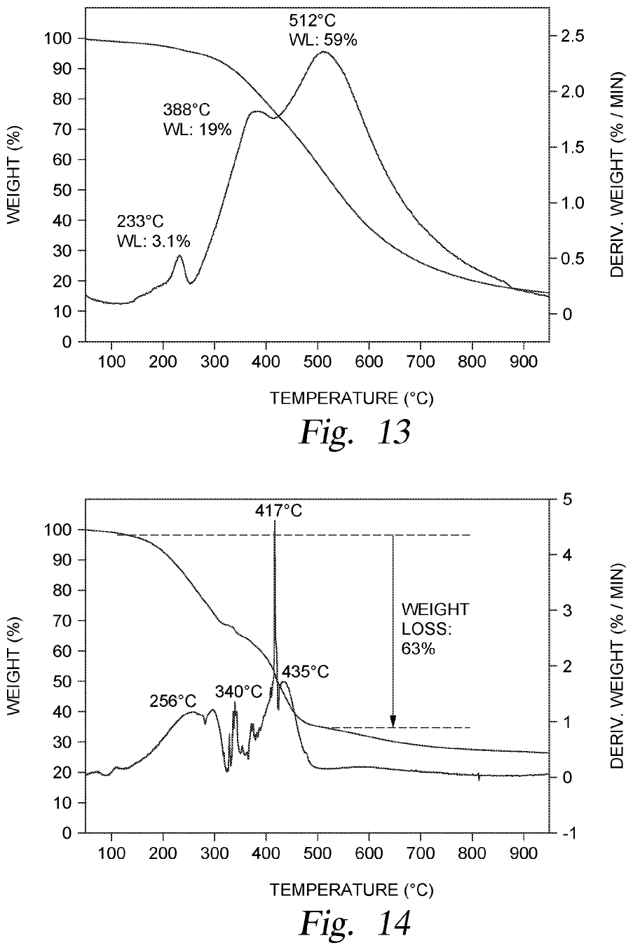

FIG. 13 is a graph illustrating the TGA of TI. At up to 120° C., there is no significant weight loss for TI. The first weight loss is observed at around 233° C., which may indicate volatilization or decomposition of low molecular weight pitch components. A major weight loss at between about 300° C. and 700° C. may indicate the decomposition of a heavy pitch molecular weight component. Between 300° C. and 700° C., the TGA curve falls steeply to give a residual weight of ash of 18%. This indicates a relatively fast evolution of volatile decomposition products in TI due to the current heating rate.

FIG. 14 is a graph illustrating the TGA of DR. At up to 120° C., there is no significant weight loss for DR. The first large weight loss is observed at around 120° C. and 500° C., which may indicate volatilization of low molecular weight pitch components and decomposition heavy molecular weight components. Between 120° C. and 500° C., the TGA curve falls steeply to give a 63% weight loss, with a residual weight of ash of 27%. The TGA may indicates that much volatile matters escaped before reaching the temperature 500° C.

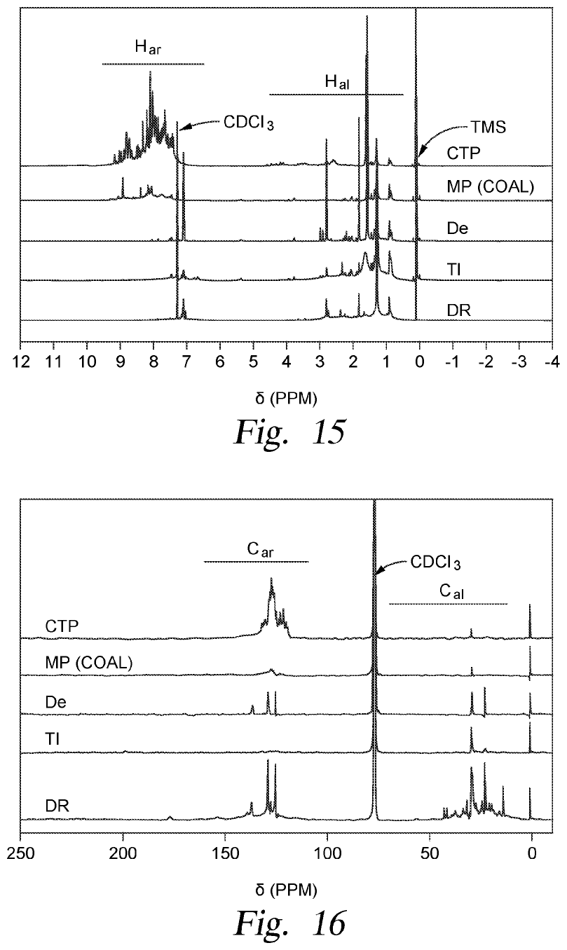

FIG. 15 is a graph illustrating the proton nuclear magnetic resonance (¹H NMR) of CDER materials and other commercial pitch materials. Table 3 shows the hydrogen distributions in CDER materials and other commercial pitch materials from ¹H NMR analysis. The chemical shifts (δ, ppm) in the ¹H NMR spectra of CDER materials and other commercial pitch materials referred to different hydrogen types. The CDER materials present a predominant aliphatic proton region (Hₐₗ, 0.5˜4.5 ppm) and a weak aromatic proton region (Hₐᵣ, 6.5˜9.5 ppm), indicating a high aliphaticity of organic species in the liquid coal extraction. In contrast, for other commercial pitch materials, such as CTP and MP (coal), the ¹H NMR spectra shows strong signals in aromatic regions and weak ones in aliphatic regions. This indicates a high aromaticity of CTP and MP (coal).

TABLE 3
Hydrogen Distributions in CDER Materials
and Other Commercial Pitch Materials.

| | | | Relative content (%) | | | | |
|---|---|---|---|---|---|---|---|
| | | | | MP | | | |
| δ (ppm) | Symbol | Assignment | CTP | (coal) | De | TI | DR |
| Aliphatic | Hₐₗ | | 17.9 | 47.7 | 81.12 | 85.7 | 83.8 |
| 0.5-1.1 | H_{γ} | Hydrogen on γ carbon | 1.05 | 6.24 | 8.38 | 13.5 | 14.33 |
| 1.1-2 | H_{β} | Hydrogen on β carbon | 8.82 | 38.77 | 59.6 | 52.1 | 44.36 |
| 2-4.5 | H_{α} | Hydrogen on α carbon | 8.07 | 2.7 | 13.13 | 20.1 | 25.16 |
| Aromatic | Hₐᵣ | | 82.1 | 52.3 | 18.88 | 14.3 | 16.16 |
| 6.5-7.2 | HₐᵣU | Uncondensed aromatic | 1.62 | 0.63 | 9.14 | 3.82 | 8.17 |
| | | hydrogen | | | | | |
| 7.2-9.5 | HₐᵣC | Condensed aromatic | 80.4 | 51.66 | 9.74 | 10.44 | 7.98 |
| | | hydrogen | | | | | |

The aliphatic protons with different δ values in other commercial pitch materials may be attributed to the hydrogen on the α-carbon attached to an aromatic ring (H_{α}, δ=2-4.5 ppm), the hydrogen on β-carbon attached to an aromatic ring (H_{β}, δ=1.1-2 ppm), and the hydrogen on γ-carbon attached to an aromatic ring (H_{γ}, δ=0.5-1.1 ppm. The aromatic protons can be classified into uncondensed aromatic hydrogen (HₐᵣU, δ=6.5-7.2 ppm) and condensed aromatic hydrogen (HₐᵣU, δ=7.2-9.5 ppm). The ratio of Hₐₗ to Hₐᵣ of the liquid CTP, MP (coal), De, TI and DR are 0.22/1, 0.91/1, 4.3/1, 6/1, and 5.2/1, respectively. The analyzed CDER materials (De, TI, and DR) have predominance of aliphaticity over aromaticity.

FIG. 16 is a graph illustrating the carbon-13 nuclear magnetic resonance (¹³C NMR) of CDER materials and other commercial pitch materials. Table 4 shows the carbon distributions in CDER materials and other commercial pitch materials from ¹³C NMR analysis. The analyzed CDER materials present a dominating aliphatic carbon region (Cₐₗ, 0˜70 ppm), followed by a strong aromatic carbon region (Cₐᵣ, 100˜160 ppm) and relatively less significant carbonyl region (C_{ca}, 170˜210 ppm). The aromaticity factor (fa=Cₐᵣ/Cₜₒₜₐₗ), i.e., aromatic carbon/total carbon ratio, of De, TI, and DR are 0.39, 0.33 and 0.35, respectively, indicating the relatively low aromaticity of the CDER materials. In contrast, for the other commercial pitch materials, such as CTP and MP (coal), the aromatic carbon region dominates over other regions, particularly for the CTP with the aromaticity approaching close to 0.9. As for the carbonyl carbon, the population in the other commercial pitch materials are negligible. The MP (coal) has a relatively high aliphatic carbon population (˜33%) than the CTP. Overall, the results from the ¹H and ¹³C NMR spectra indicate the same structure fingerprints in the CDER materials and other commercial pitch materials. The CDER materials exhibit high aliphaticity and relativity low aromaticity, while the other commercial pitch materials exhibit an opposite behavior. Meanwhile, the CTP and MP (coal) have differences in the sense that aliphaticity and aromaticity are almost equally strong in the MP pitch.

TABLE 4
Carbon Distributions in CDER Materials and Other Commercial Pitch Materials.

| | | | Relative content (%) | | | | |
|---|---|---|---|---|---|---|---|
| | | | | MP | | | |
| δ (ppm) | Symbol | Assignment | CTP | (coal) | De | TI | DR |
| Aliphatic | Cₐₗ | | 8.72 | 32.55 | 47.95 | 52.6 | 62.28 |
| 12-24 | Cₐₗ₁ | Aliphatic CH₃ & | 1.75 | 6.46 | 12.25 | 9.84 | 20 |
| | | aromatic CH₃ | | | | | |
| 24-35 | Cₐₗ₂ | Methylene C | 2.24 | 8.4 | 14.58 | 19 | 32.32 |
| 35-50 | Cₐₗ₃ | Methine & quaternary | 2.23 | 7.4 | 9.83 | 10.64 | 6.1 |
| | | C | | | | | |
| 50-70 | Cₐₗ₄ | Aliphatic C bonded to | 2.49 | 10.29 | 11.29 | 13.08 | 3.85 |
| | | O | | | | | |
| Aromatic | Cₐᵣ | | 89.11 | 56.6 | 39.5 | 33.45 | 35 |
| 110-129.5 | Cₐᵣ₁ | Protonated aromatic | 63.35 | 29.74 | 18.24 | 14.7 | 18.34 |
| | | C & peri-condensed | | | | | |
| | | aromatic C | | | | | |
| 129.5-137 | Cₐᵣ₂ | cata-Condensed | 16 | 13.63 | 5.56 | 5.79 | 7.54 |
| | | aromatic C | | | | | |
| 137-160 | Cₐᵣ₃ | Aromatic C bonded to | 9.74 | 13.24 | 15.7 | 12.97 | 9.31 |
| | | heteroatom or alkyl | | | | | |
| | | groups | | | | | |
| Carbonyl | C_{ca} | | 2.17 | 10.84 | 12.55 | 13.98 | 2.53 |
| 170-180 | C_{ca1} | C in —COOH and —COOR | 1.1 | 5.84 | 6.26 | 6.7 | 1.38 |
| 200-210 | C_{ca2} | C in C═O and —CHO | 1.07 | 5 | 6.29 | 7.28 | 1.15 |

Table 5 is a summary of the heat treating experiments for De and TI. Heat treating the CDER materials may increase the content of heavy molecular weight components, improving the ability of CDER materials to act as a binder material. The heat-treatment occurs between 410° C. and 450° C. Heat-treating the CDER materials may cause volatilization of low molecular mass constituents of the pitch and polymerization and condensation reactions of the hydrocarbons. In addition, hydrogenation, fragmentation, alkylation or dehydrogenative polymerization may occur during heat treatment. Thermal cracking of the aliphatic side group at the a-position in the aromatic molecules may result in the free radicals. These free aromatic radicals react with each other to produce aryl-aryl linkages and then build up the polyaromatic molecules to form a carbonaceous mesophase.

TABLE 5
Summary of the Heat Treating Experiments for De and TI.

| | | Treatment | Heating | | | |
|---|---|---|---|---|---|---|
| | | temperature | rate | Soaking | Purge | Yield |
| Sample | Pressure | (C.) | (C./min) | time (h) | gas | (%) |
| De | Ambient | 410 | 1 | 10 | Argon | ~76 |
| | pressure | | | | flow | |
| De | Ambient | 430 | 1 | 10 | Argon | ~75.8 |
| | pressure | | | | flow | |
| De | Ambient | 450 | 1 | 10 | Argon | ~75.2 |
| | pressure | | | | flow | |
| TI | Ambient | 410 | 1 | 10 | Argon | ~76.5 |
| | pressure | | | | flow | |
| TI | Ambient | 430 | 1 | 10 | Argon | ~76 |
| | pressure | | | | flow | |
| TI | Ambient | 450 | 1 | 10 | Argon | ~75.5 |
| | pressure | | | | flow | |

Based on the results from the ¹H and ¹³C NMR spectra, all the coal extractions exhibit high aliphaticity and relativity low aromaticity, while the MP exhibits an opposite behavior. Therefore, the coal extractions can be heat-treated to improve their aromaticity before being used as binder materials. During the heat-treatment process, the pressure inside of the electric furnace is at the ambient pressure. The heat-treatment is carried out at a specific temperature for 10 hours. The gas flow rate of argon was about 100 ml/min.

The aromaticity indices of De, TI and heat-treated products can be calculated using absorbance values at wavenumbers of 3050 cm⁻¹ and 2920 cm⁻¹ given by Equation (1):

$${I}_{ar} = \frac{{h}_{3050}}{( {h}_{3050} + {h}_{2920} )} \qquad ( 1 )$$

Where h₃₀₅₀ is the peak height of aromatic C—H stretching alkane at a wavenumber of about 3050 cm⁻¹, and h₂₉₂₀ means the peak height of aliphatic C—H stretching alkane at a wavenumber of about 2920 cm⁻¹.

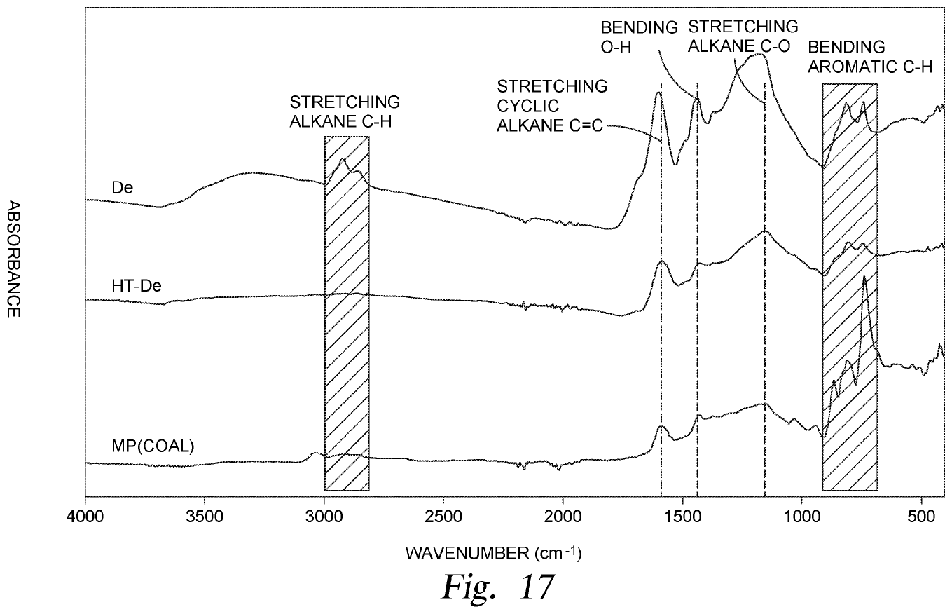

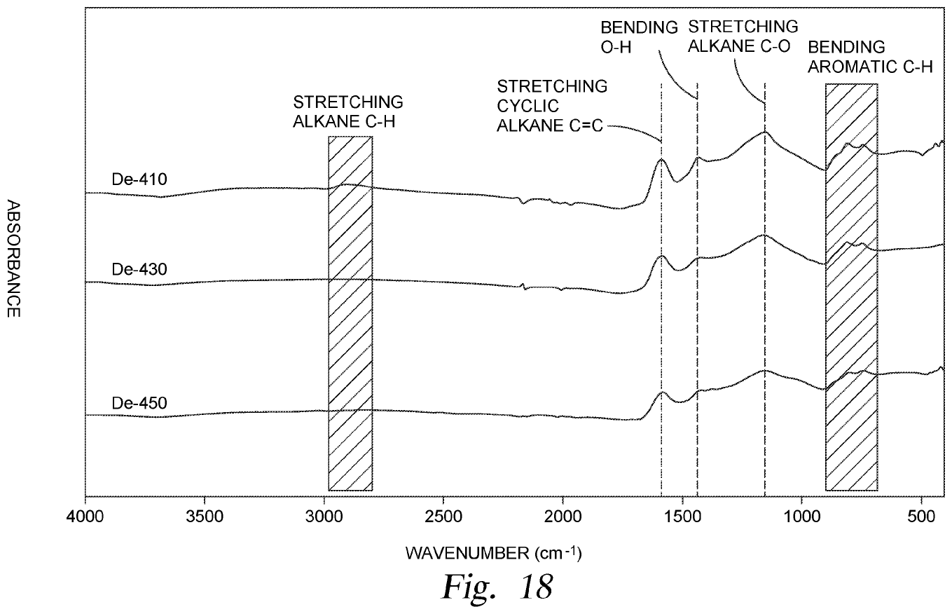

FIG. 17 is a graph illustrating the FTIR analysis of De, MP (coal), and heat-treated De. The De was heat treated at 430° C. FIG. 18 is a graph illustrating the FTIR analysis of heat treated De. The De was heat treated at 410° C., 430° C., and 450° C. The De is thermally heated to the specified temperature (410° C., 430° C., or 450° C.) and held at this temperature for 10 hours. The FTIR spectra signals of various functional groups (e.g., alkane and some aromatic groups) of heat-treated De are compared to the untreated De. With heat-treatment of De at 430° C., volatile matter is released, including light weight alkane and aromatic group. Compared to MP (coal), the thermal-treated De presents weaker signals at near 3050 cm⁻¹ and 750 cm⁻¹, indicating lower content of aromatic hydrogen groups. Applying equation (1), the aromaticity index of each product is estimated. Before heat treatment, the aromaticity index of De is about 43.3%. After heat treatment at 410° C., the aromaticity index increases to about 48.6%. After heat treatment at 430° C., the aromaticity index increases to about 49.5%. After heat treatment at 450° C., the aromaticity index increases to about 49.4%. The heat-treatment increased the amount of aromaticity in the DE material.

The bending aromatic C—H to stretching cyclic alkane C═C peak intensity ratio is used to reflect the condensation degree of polycyclic aromatic hydrocarbons. The condensation degree of polycyclic aromatic hydrocarbon of De, De-410, De-430, and De-450 are 0.65, 0.97, 0.98, and 1.1, respectively. These demonstrate that the condensation degrees of the heat-treated CDER materials increase with increasing the heat-treatment temperature. De-450 shows the highest condensation degree than those of DE-430 and DE-410.

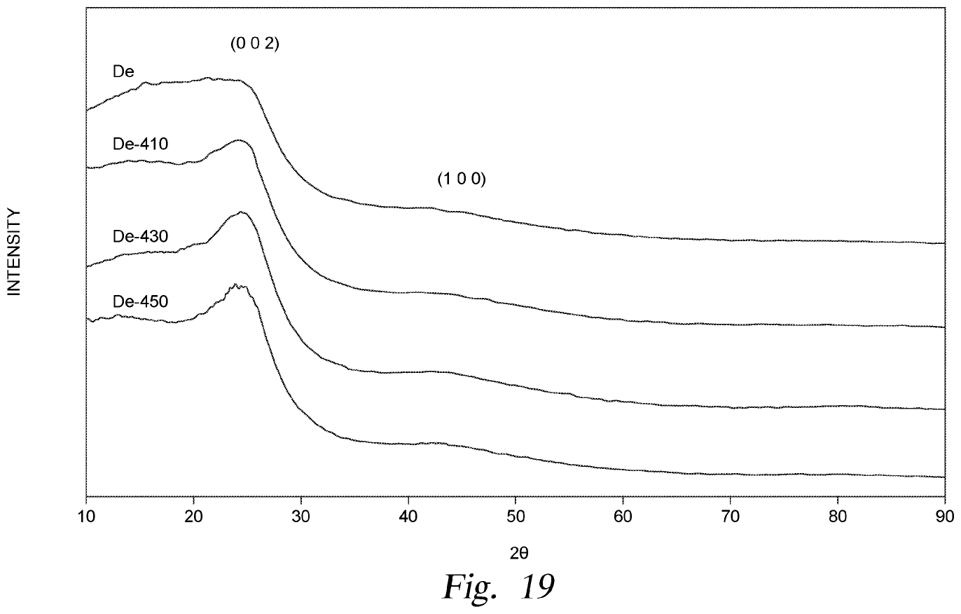

FIG. 19 is a graph illustrating the XRD analysis of the heat-treated De. The XRD analysis determines the crystallinity of the De. The XRD diffraction peaks at 2-theta (2θ) values between 25° and 43° may correspond to the graphitic basal plane reflection. The broad diffraction peak at around 2θ=25.4° corresponds to (0 0 2) crystal planes may be due to the stacking of aromatic layers. The weak broad peak at around 43° may be attributed to (1 0 0) crystal faces reflection, demonstrating the graphitic crystalline feature of the De. The intensity of the peak between 25.4° and 43° increases with increasing the thermal treatment temperature, which may indicate the stable aromatic form of carbon species in the De.

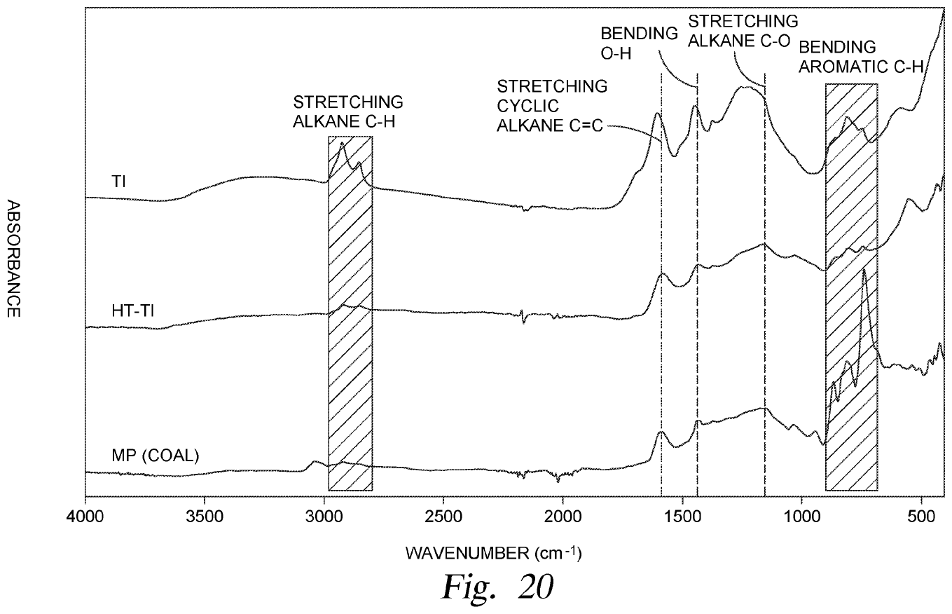

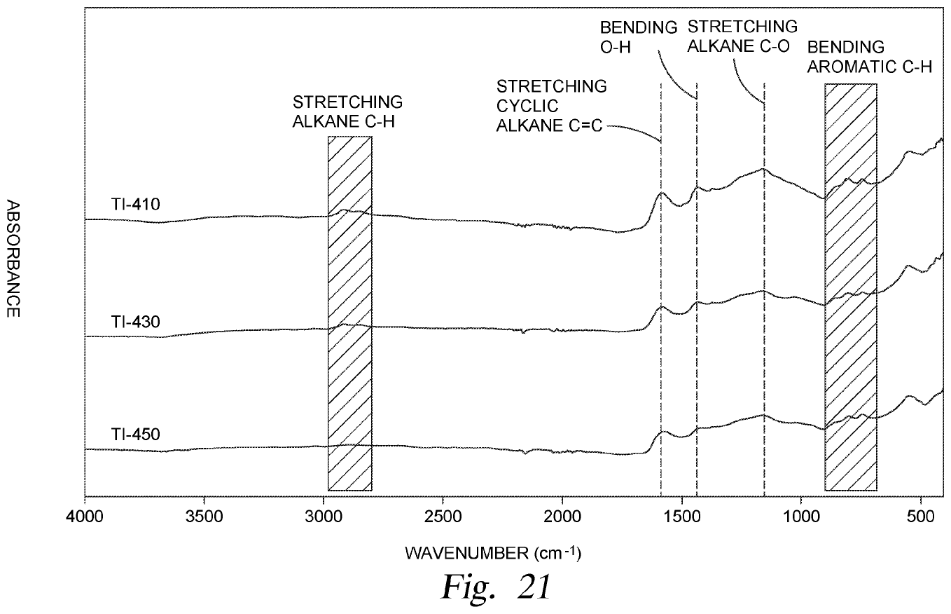

FIG. 20 is a graph illustrating the FTIR analysis of TI, MP (coal), and heat-treated TI and other commercial pitch materials. The TI was heat-treated at 430° C. FIG. 21 is a graph illustrating the FTIR analysis of heat treated TI. The TI was heat-treated at 410° C., 430° C., and 450° C. After heat-treatment, the spectra signals of functional groups (e.g., alkane and some aromatic groups) became less compared to the untreated raw material. Meanwhile, increasing the heat treatment temperature results in weaker spectra signals for different functional groups, which may indicate more lightweight components volatize at a higher temperature. According to Equation (1), the aromaticity index of raw TI material is estimated at 33.5%, while the aromaticity indices increase to 46.7%, 47.7%, and 49.6% for TI-410, TI-430, and TI-450, respectively. In this case, TI-450 presents the highest aromaticity index. The condensation degree of polycyclic aromatic hydrocarbon of TI, TI-410, TI-430, and TI-450 are 0.719, 1.05, 1.15, and 1.11, respectively. This shows that TI-430 possesses the highest value of condensation degree, but very close to that of TI-450.

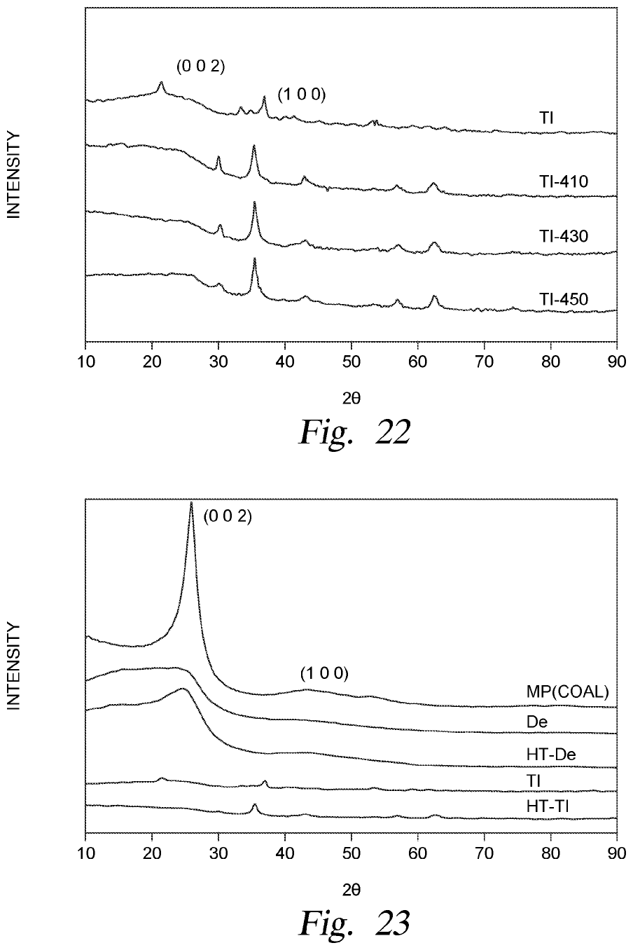

FIG. 22 is a graph illustrating the XRD analysis of the heat-treated TI. The intensity of the peaks between 25.4° C. and 43° C. slightly increase with increasing the thermal treatment temperature. Compared with the XRD results of De, those sharp diffraction peaks may be due to minerals in the TI. Minerals in the TI may indicate that the TI has more ashes or minerals than the De material. In addition, those sharp diffraction peaks became more and more intensive with increasing the thermal treatment temperature.

FIG. 23 is a graph illustrating the XRD analysis of CDER materials, heat-treated CDER materials, and other commercial pitch materials. Compared to the commercial mesophase pitch (coal), heat-treated De and TI show much weaker peaks at around 25.4° C. and 43° C. Especially for the TI, the peaks are negligible. The aromatic component of De increases with heat treatment.

Table 6 is a summary of the composition of CDER materials, heat-treated CDER materials, and other commercial pitch materials. The compositions include untreated De (De); 410° C. heat-treated De (De-410); 430° C. heat-treated De (De-430); 450° C. heat-treated De (De-450); untreated TI (TI); 410° C. heat-treated TI (TI-410); 430° C. heat-treated TI (TI-430); 450° C. heat-treated TI (TI-450); and untreated MP (MP). The TGA test includes: the temperature ramps from room temperature to 110° C. in a nitrogen atmosphere and the isothermal time is 50 mins. The ramp rate is 5° C./min. This process can be used to estimate the moisture content of the CDER material. Then, the temperature ramps from 110° C. to 950° C. at the ramp rate of 30° C./min. The CDER material is held at 950° C. for 5 mins. After that, temperature decreases from 950° C. to 600° C. at the ramp rate of 10° C./min. Lastly, the purge gas is changed to air. Temperature increases from 600° C. to 750° C. at the ramp rate of 10° C./min, and the isothermal time is 50 mins.

TABLE 6
Summary of Composition of CDER Materials, Heat Treated
CDER Materials and Other Commercial Pitch Materials.

| | | | | | | Proximate analysis (w/w %) | | | |
|---|---|---|---|---|---|---|---|---|---|
| | Ultimate analysis (w/w %) | | | | | | | Fixed | |
| CDER | N | C | O | H | S | Moisture | Volatile | carbon | Ash |
| De | 2.15 | 78.37 | 9.61 | 5.38 | 0.65 | 2.16 | 40.2 | 55.9 | 1.68 |
| De-410 | 2.07 | 80.45 | 9.64 | 4.25 | 0.39 | 2 | 24.8 | 72 | 1.2 |
| De-430 | 2.04 | 79.97 | 9.72 | 4.06 | 0.34 | 2.1 | 24.75 | 71.37 | 1.77 |
| De-450 | 2.09 | 81.2 | 9.91 | 3.82 | 0.31 | 2.3 | 26.74 | 70.57 | 0.37 |
| TI | 1.17 | 63.37 | 11.44 | 5.16 | 0.43 | 1.63 | 48.4 | 33.2 | 16.8 |
| TI-410 | 1.3 | 66.83 | 4.51 | 3.76 | 0.47 | 1.73 | 34.7 | 42.17 | 21.4 |
| TI-430 | 0.02 | 67.55 | 9.73 | 2.845 | 0.49 | 0.77 | 33.9 | 46.72 | 18.6 |
| TI-450 | 1.32 | 65.5 | 7.52 | 2.98 | 0.5 | 2.28 | 32.4 | 45.3 | 19.9 |
| MP | 1.67 | 84.07 | 9.86 | 3.63 | 0.77 | 0.12 | 13.76 | 85.9 | 0.22 |

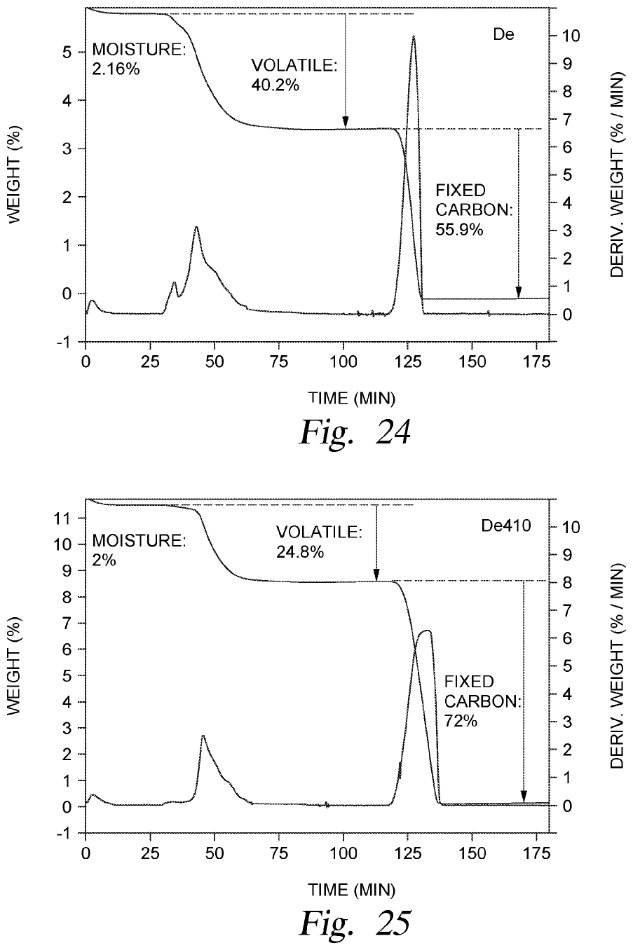

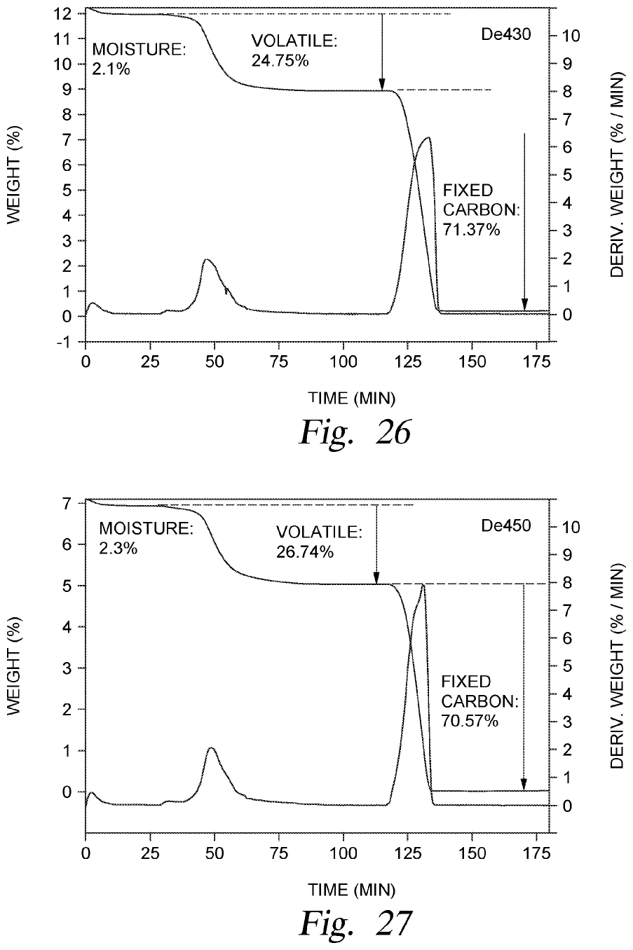

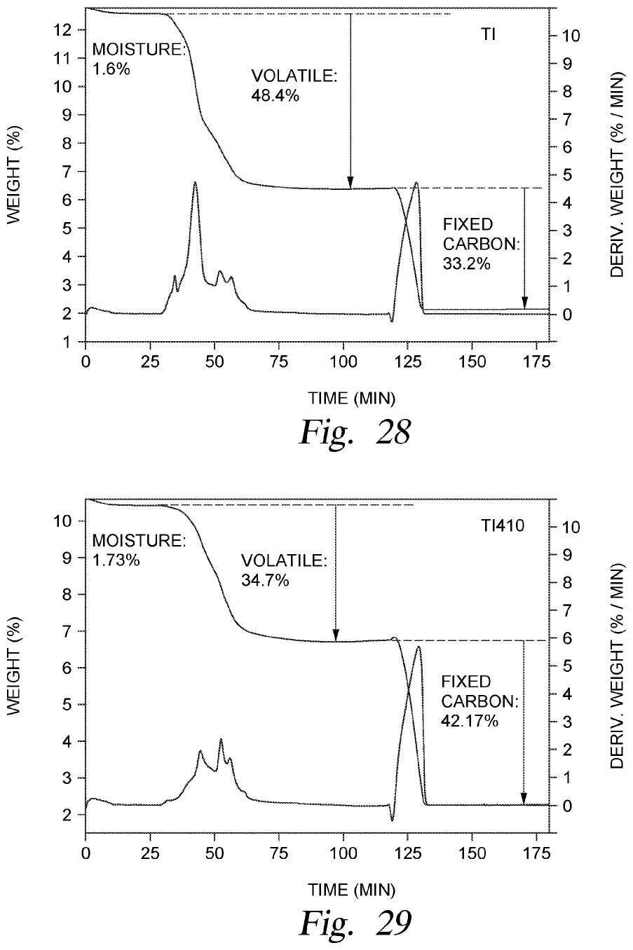

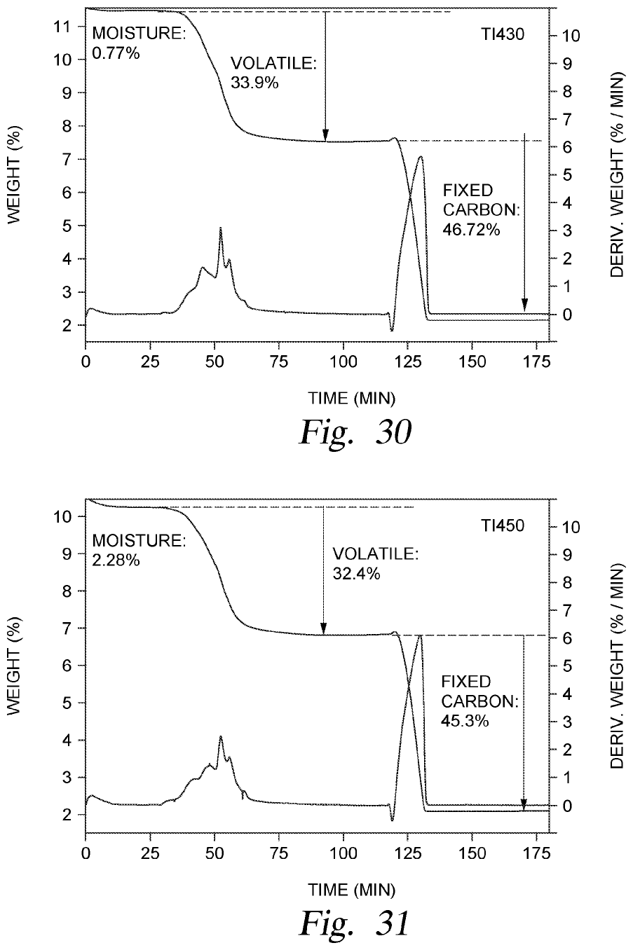

FIG. 24 is a graph illustrating the TGA proximate analysis of De. FIG. 25 is a graph illustrating the TGA proximate analysis of De heat-treated at 410° C. FIG. 26 is a graph illustrating the TGA proximate analysis of De heat-treated at 430° C. FIG. 27 is a graph illustrating the TGA proximate analysis of De heat-treated at 450° C. FIG. 28 is a graph illustrating the TGA proximate analysis of TI. FIG. 29 is a graph illustrating the TGA proximate analysis of TI heat-treated at 410° C. FIG. 30 is a graph illustrating the TGA proximate analysis of TI heat-treated at 430° C. FIG. 31 is a graph illustrating the TGA proximate analysis of TI heat-treated at 450° C.

Comparing De and heat-treated De, heat-treated De significantly increases the fixed carbon content from 55.9% of De to 72% of De-410. However, due to the small temperature difference, a large difference in fixed carbon contents for De-410, De-430, and De-450 is not observed. For TI and heat-treated TI, the fixed carbon content increases from 33.2% to 46.72%. Among them, TI-430 exhibits the highest fixed carbon content of 46.72%. The fixed carbon content for MP (coal) is about 85.9%, which is higher than that of De, heat-treated De, TI, and heat-treated TI. The ultimate analysis results indicate that the fixed carbon content increases with heat-treatment for De and TI. Furthermore, the C/H ratio increases from 14.58 of De to the highest ratio 21.27 in the heat-treated De-450. For TI and heat-treated TI, the ratios of C/H for TI, TI-410, TI-430, and TI-450 are 12.28, 17.7, 23.74, and 21.98, respectively. TI-430 shows the highest C/H ratio. The C/H ratio of MP (coal) is around 23.16, similar as the heat-treated De-430.

Pressure heat-treating (P&H treating) CDER materials may increase the aromatic index and the content of heavy molecular weight components in the CDER materials. The treatment is conducted using an electrical strip reactor. During the treatment, an applied pressure at about 4 MPa is maintained at 430° C. for about 5.25 hours in nitrogen environment. The heating rate is 5° C./min, and it takes around 82 minutes to reach 430° C. After the completion of heat treatment, the heater is turned off and left for 12 hours before cooling to room temperature. Due to the treatment, weight losses of 21.0% and 27.6% are observed for De and TI, respectively. The CDER materials melts at this temperature, and volatile materials evaporate.

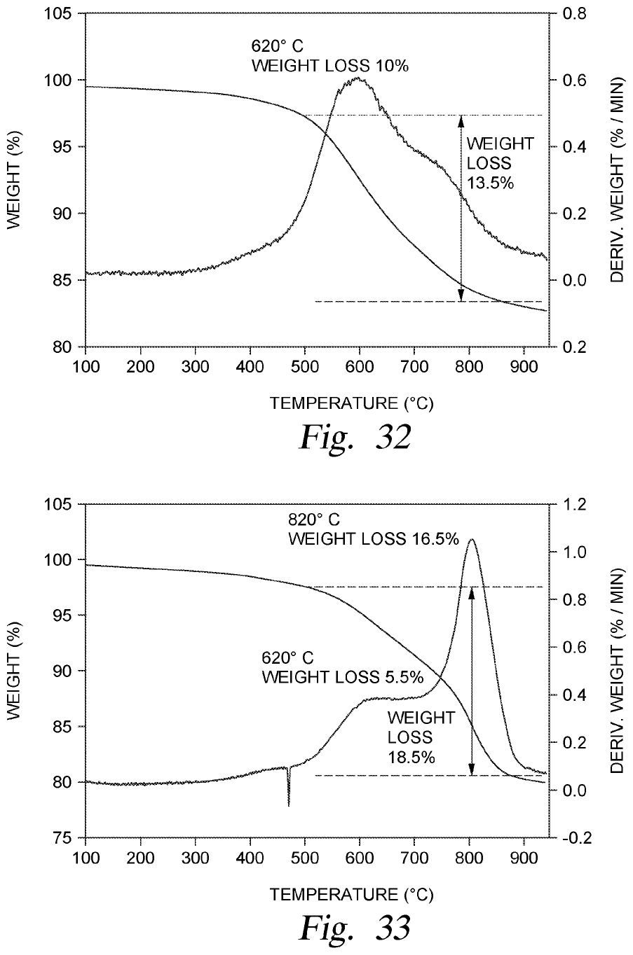

FIG. 32 is a graph illustrating the TGA of P&H treated De. FIG. 33 is a graph illustrating the TGA of P&H treated TI. The TGA is conducted up to 950° C. with a heating rate of 10° C./min in nitrogen environment. The TGA results are then compared with that of the untreated De. There is only slight weight loss for the untreated De up to 300° C. due to volatilization or decomposition of low molecular weight components. The major weight loss of about 92.5% is observed between 300° C. and 650° C. with the maximum decomposition rate at 539° C. due to decomposition of the heavy molecular weight components. The P&H treated De has no significant weight loss before 500° C. as all the volatile matters have already been volatilized during the treatment. The major weight loss is observed between 500° C. and 850° C. with the maximum decomposition rate at 620° C. A residue weight of approximately 83% at 950° C. for P&H treated De is obtained, whereas only 3.5% residue is obtained for untreated De at 650° C.

For the untreated TI, when the temperature reaches at around 233° C., there is only about 3% of weight loss due to volatilization or decomposition of low molecular weight pitch components. The major weight loss is observed between 300° C. and 700° C. with the maximum decomposition rate at 512° C. which may be due to decomposition of the heavy molecular weight components. However, P&H treated TI has no significant weight loss before 500° C. as all the volatile matters should have already been volatilized during the P&H treatment. The major weight loss is observed between 500° C. and 850° C. with the maximum decomposition rate at 820° C. A residue weight of approximately 80% for P&H treated TI is obtained, whereas only 3.5% residue is obtained for untreated TI at 950° C. Therefore, to proceed with the P&H treated De and TI for carbonization, a temperature higher than 500° C. is needed. After carbonization at 900° C., less micro-cracks are found in the CSUs prepared with P&H treated CDER materials due to lesser weight loss.

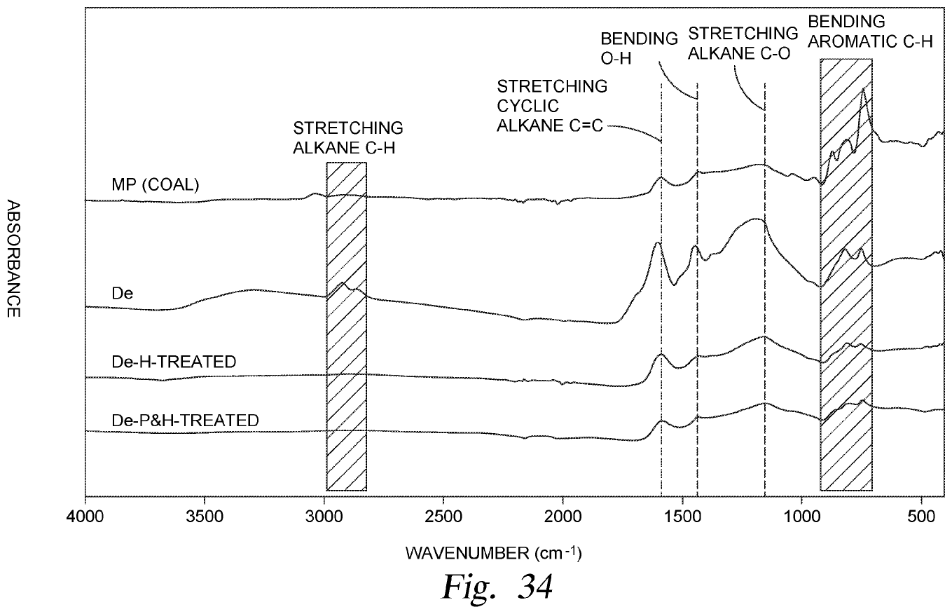

Table 7 is a summary of the aromaticity index of the CDER materials. FIG. 34 is a graph illustrating the FTIR analysis of MP (coal) and De. Comparing the spectra of MP (coal), the untreated De, heat-treated De, and P&H treated De present weaker signals at near 3050 cm⁻¹ and 750 cm⁻¹, indicating lower content of aromatic hydrogen groups. The aromaticity index of De increases from 43.3% before heat-treatment to 49.8% due to pressurized heat-treatment. The isolated aromatic C—H:aromatic C═C peak intensity ratio was used to indicate the condensation degree of polycyclic aromatic hydrocarbons. The condensation degree of polycyclic aromatic hydrocarbon of De, heat-treated De, and P&H treated De are 0.65, 0.98, and 1.1, respectively. Hence, the length of molecular chain increases with the treatment of the De.

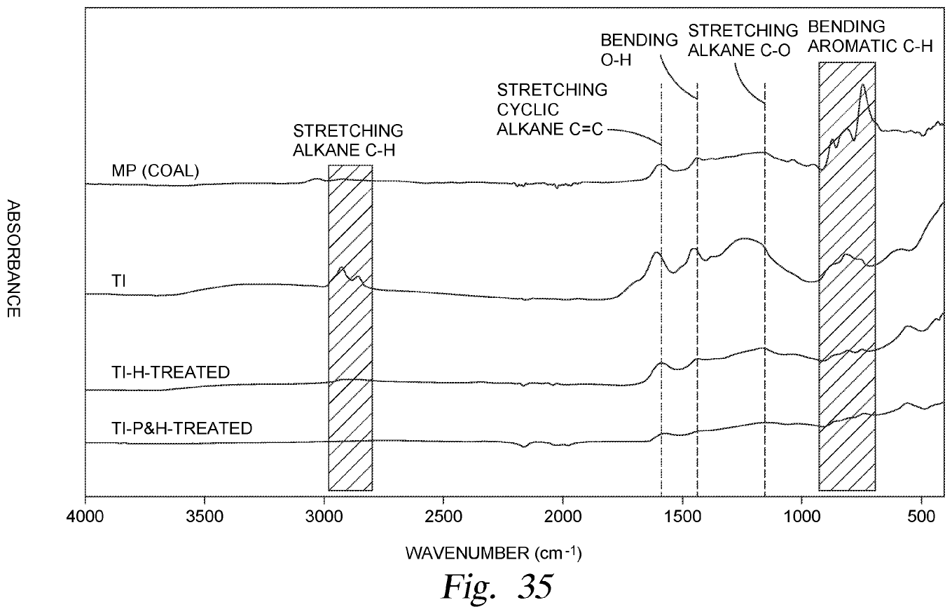

FIG. 35 is a graph illustrating the FTIR analysis of MP (coal) and TI. Similar to De, the untreated TI, heat-treated TI, and P&H treated TI present weaker signals at near 3050 cm⁻¹ and 750 cm⁻¹, indicating lower content of aromatic hydrogen groups compared to MP (coal). The aromaticity index of TI increases from 33.5% to 47.7% due to heat-treatment and to 49.9% due to P&H treatment. The condensation degree of polycyclic aromatic hydrocarbon of TI, heat-treated TI, and P&H-treated TI are 0.72, 1.05, and 1.18, respectively. Similarly, the treatment of TI may increase the length of the molecular chain.

TABLE 7
Summary of the Aromaticity Index of CDER Materials.

| | TI | | | De | | |
|---|---|---|---|---|---|---|
| | | | Pressurized | | | Pressurized |
| | | Heat- | at 4 MPa | | Heat- | at 4 MPa |
| Sample/ | | treated | and heated | | treated | and heated |
| Characteristic | Untreated | at 430° C. | at 430° C. | Untreated | at 430° C. | at 430° C. |
| Aromaticity Index (%) | 33.5 | 47.7 | 49.9 | 43.3 | 49.5 | 49.8 |
| Condensation degrees | 0.72 | 1.05 | 1.18 | 0.65 | 0.98 | 1.10 |

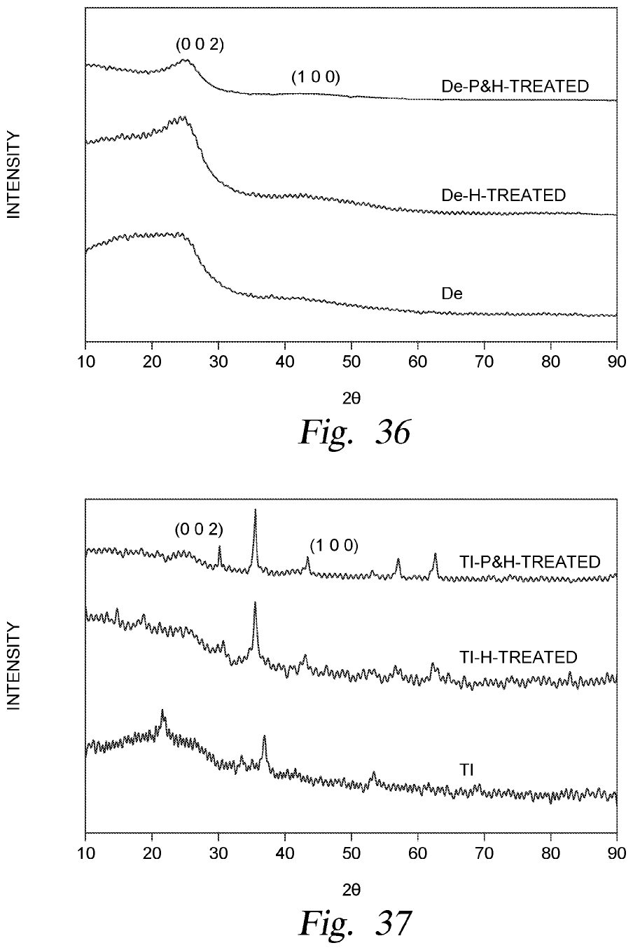

FIG. 36 is a graph illustrating the XRD analysis of the De, heat-treated De, and P&H treated De. The broad diffraction peaks at 2θ of 25.4° and 43° may correspond to (0 0 2) crystal planes may be due to the stacking of aromatic layers and (1 0 0) crystal faces reflection may demonstrate the graphitic crystalline feature, respectively. Peaks at 2θ=25.4° and 43° of P&H-treated De are lower than that of heat-treated De (FIG. 3.9). The intensity of the peak at 25.4° increases with the heat-treated De and P&H treated De, which may indicate the stable aromatic form of carbon species in the heat-treated De and P&H treated De.

FIG. 37 is a graph illustrating the XRD analysis of the TI, heat-treated TI, and P&H treated TI. Significant sharp peaks may be due to more crystallized minerals in the P&H-treated TI are observed. The intensity of the peaks between 25.4° and 43° also slightly increases with heat-treatment TI and P&H treatment TO.

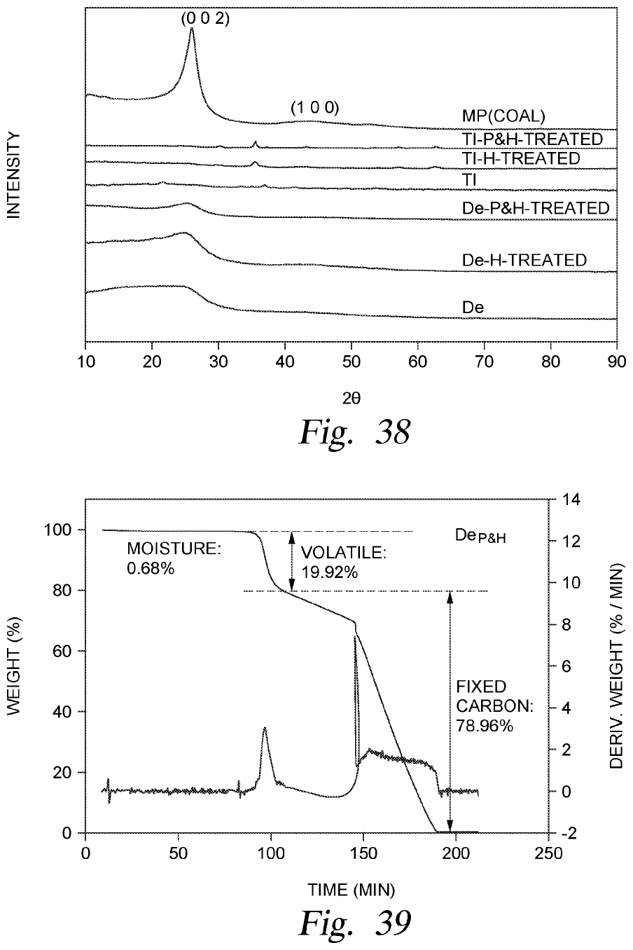

FIG. 38 is a graph illustrating the XRD analysis of the De, heat-treated De, P&H treated De, TI, heat-treated TI, P&H treated TI, and MP (coal). Compared to the commercial MP (coal), heat-treated and P&H-treated De and TI exhibit much weaker peaks at around 25.4° and 43°. In particular, the peaks of all the TI are negligible. The aromatic component of De increases with heat-treatment and P&H treatments.

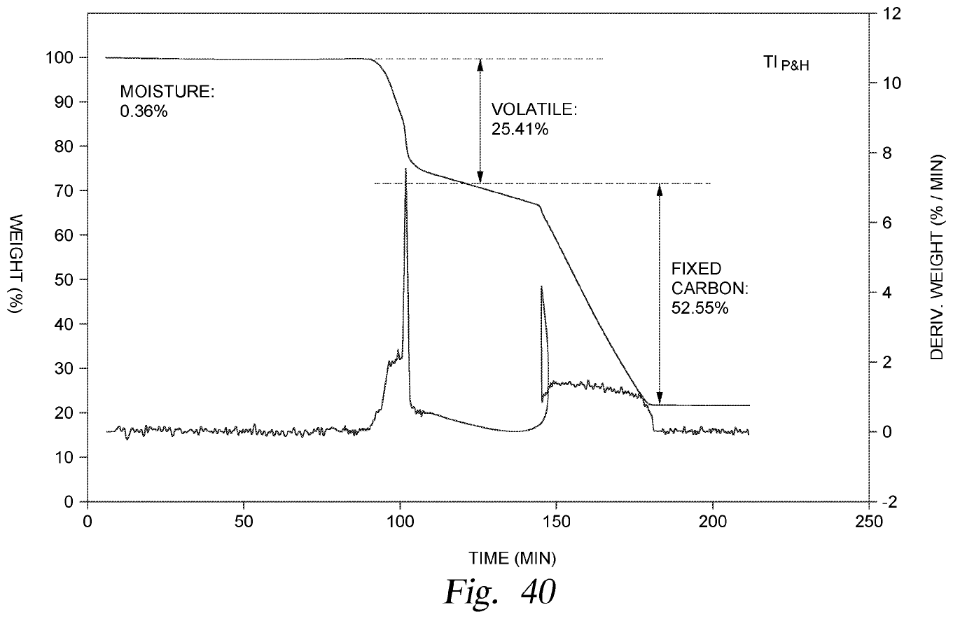

Table 8 is a summary of the composition of CDER materials, heat-treated CDER materials, P&H treated CDER materials, and other commercial pitch materials. The compositions include PC (Char); untreated De (De); heat-treated De (De_{H-treated}); P&H treated De (De_{P&H-treated}); untreated TI (TI); heat-treated TI (TI_{H-treated}); P&H treated TI (TI_{P&H-treated}); and untreated MP (MP). FIG. 39 is a graph of the TGA of P&H treated De. FIG. 40 is a graph of the TGA of P&H treated TI. The fixed carbon and carbon content increase with heat-treatment and P&H-treatment, whereas volatile matter, ash content, and moisture decrease.

TABLE 8
Summary of the Composition of CDER Materials, Heat Treated CDER Materials,
P&H Treated CDER Materials, and Other Commercial Pitch Materials.

| | | | | | | Proximate analysis (w/w %) | | | |
|---|---|---|---|---|---|---|---|---|---|
| | Ultimate analysis (w/w %) | | | | | | | Fixed | |
| Materials | N | C | O | H | S | Moisture | Volatile | carbon | Ash |
| Char | 1.04 | 82.00 | 14.60 | 2.07 | 0.79 | 2.97 | 15.96 | 79.87 | 1.2 |
| De | 2.15 | 78.37 | 9.61 | 5.38 | 0.65 | 2.16 | 40.2 | 55.9 | 1.68 |
| De_{H-treated} | 2.04 | 79.97 | 9.72 | 4.06 | 0.34 | 2.1 | 24.75 | 71.37 | 1.77 |
| De_{P&H-treated} | 1.12 | 85.63 | 8.35 | 3.41 | 0.37 | 0.68 | 19.92 | 78.96 | 0.44 |
| TI | 1.17 | 63.37 | 11.44 | 5.16 | 0.43 | 1.63 | 48.4 | 33.2 | 16.8 |
| TI_{H-treated} | 0.02 | 67.55 | 9.73 | 2.85 | 0.49 | 0.77 | 33.9 | 46.72 | 18.6 |
| TI_{P&H-treated} | 1.23 | 72.10 | 1.98 | 2.06 | 0.59 | 0.36 | 25.41 | 52.55 | 21.68 |
| MP | 1.67 | 84.07 | 9.86 | 3.63 | 0.77 | 0.12 | 13.76 | 85.9 | 0.22 |

Table 9 is a summary of the thermal and mechanical properties of carbon-based structural units (CSUs). The CSUs include a 100 MPa pressing pressure/700° C. carbonization temperature sample (1); a 100 MPa pressing pressure/700° C. carbonization temperature sample (2); a 200 MPa pressing pressure/700° C. carbonization temperature sample (3); a 200 MPa pressing pressure/700° C. carbonization temperature sample (4); a 100 MPa pressing pressure/900° C. carbonization temperature sample (5); a 100 MPa pressing pressure/900° C. carbonization temperature sample (6); a 200 MPa pressing pressure/900° C. carbonization temperature sample (7); a 200 MPa pressing pressure/900° C. carbonization temperature sample (8); and a 400 MPa pressing pressure/700° C. carbonization temperature sample (9); MP (coal) is mixed with PC at a mass ratio of 1:2 to form a pitch mixture. The pitch mixture is ball milled, dried, and pressed into a CSU at a pressure from 100 MPa to 200 MPa. The tablet samples are thermally treated. In an oxidation stabilization process, the CSU is first heated to 240° C. in an air atmosphere at a rate of 1° C./min and held at this temperature for 16 hours. In a carbonization process, the CSU is heated to a higher temperature, about 700° C. to about 900° C., in an argon atmosphere at a rate of 3° C./min and held at this temperature for about 1 hour.

TABLE 9
Summary of the Thermal and Mechanical Properties of CSUs.

| | | | | Density of | | |
|---|---|---|---|---|---|---|
| | | | Density | final sample | | |
| | Pressing | Carbonization | of original | carbonized | Thermal | Compressive |
| Sample | pressure | Temperature | tablet sample | at 700° C. | conductivity | strength |
| # | (MPa) | (° C.) | (g/cm³) | (g/cm³) | (W/m · K) | (MPa) |
| 1 | 100 | 700 | 1.020 | 0.972 | 0.175 | 42.7 |
| 2 | 100 | 700 | 1.018 | 0.967 | | |
| 3 | 200 | 700 | 1.126 | 1.087 | 0.185 | 85.6 |
| 4 | 200 | 700 | 1.130 | 1.090 | | |
| 5 | 100 | 900 | 1.070 | 1.055 | 0.217 | 89.1 |
| 6 | 100 | 900 | 1.077 | 1.060 | | |
| 7 | 200 | 900 | 1.161 | 1.133 | 0.241 | 109 |
| 8 | 200 | 900 | 1.158 | 1.129 | | |
| 9 | 400 | 700 | 1.680 | 1.530 | 0.282 | 91.5 |

Higher pressing pressure slightly increases the density and thermal conductivity of the CSUs. The compressive strengths of the CSUs are 42.7 MPa for CSU pressed at 100 MPa and 85.6 MPa for the CSU pressed at 200 MPa pressing pressures. Hence, higher pressing pressure significantly increases the compressive strength of the CSU products. In contrast, increasing the pressing pressure from 200 to 400 MPa does not significantly increase the compressive strength (from 85.6 MPa to 91.5 MPa or only 6.4% improvement). In addition, increasing the pressing pressure from 200 to 400 MPa increases the thermal conductivity by 52.4%, thus reducing insulative properties of the CSU.

The CSU carbonized at 900° C. has higher thermal conductivity values of 0.217 and 0.241 W/m·K compared to that of the CSU carbonized at 700° C., indicating that a lower carbonization temperature has increased insulation properties. The thermal treatment and carbonization slightly decrease the density. The compressive strengths of the CSU carbonized at 900° C. are 89.1 MPa for the CSU pressed at 100 MPa and 109 MPa for the CSU pressed at 200 MPa.

Increased carbonization temperature increases the compressive strength of CSU. Compared to 700° C. carbonization temperature, the higher carbonization temperature of 900° C. yields higher compressive strength. However, a temperature higher than 900° C. may not necessarily increase the compressive strength because higher temperature results more graphite and may weaken the mesophase pitch binding.

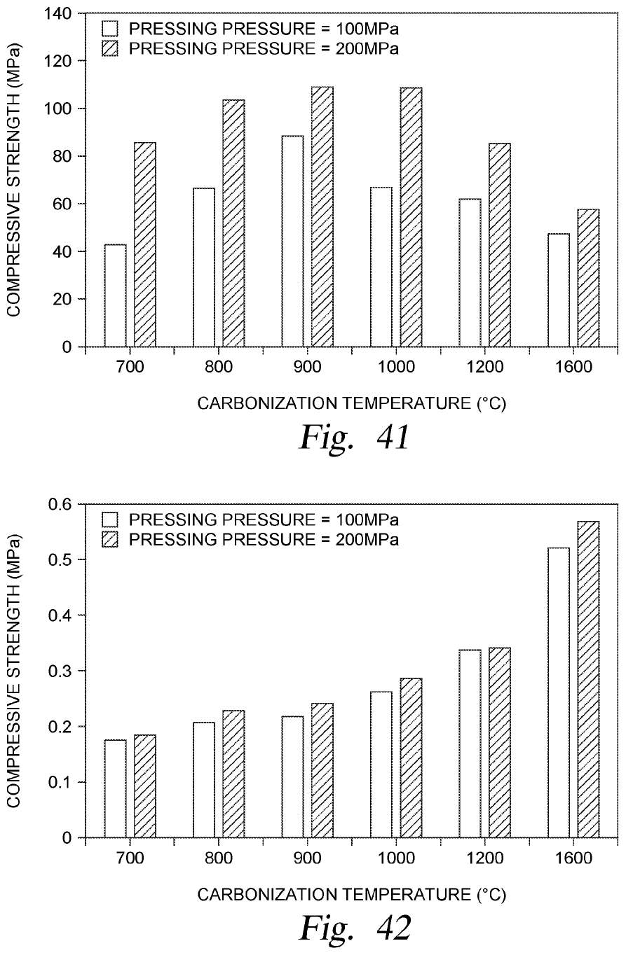

FIG. 41 is a graph illustrating the compressive strength of CSUs varied by carbonization temperature. FIG. 42 is a graph illustrating the thermal conductivity of CSUs varied by carbonization temperature. For the pressing pressures of 100 MPa and 200 MPa, higher pressing pressure results in larger compressive strength. With increasing the carbonization temperature, compressive strength firstly increases and then decreases when the temperature exceeds 900° C. The CSU pressed at 200 MPa and carbonized at 900° C. shows the highest compressive strength of 109 MPa. Meanwhile, the CSU carbonized at 900° C. and pressing at 100 MPa also produces relatively higher compressive strength of 88.1 MPa. The thermal conductivity increases as the carbonization temperature increases for both 100 MPa and 200 MPa.

Table 10 is a summary of the thermal and mechanical properties of CSUs with a MP:PC mass ratio of 1:3. The CSUs include a first and second CSU. A pressing pressure of 200 MPa and carbonization temperature of 900° C. yields the compressive strength of 57.6 MPa and 67.5 MPa, which are lower than the compressive strength of CSU for MP:PC=1:2. The MP: PC mass ratio of 1:3 yields comparable density and higher thermal conductivity (e.g., lesser insulation properties) to the MP:PC mass ratio of 1:2.

TABLE 10
Summary of the Thermal and Mechanical Properties
of CSUs with a MP:PC Mass Ratio of 1:3.

| | | Density of | Density of | | |
|---|---|---|---|---|---|
| | | original | final sample | | |
| | Pressing | tablet | carbonized | Thermal | Compressive |
| Sample | pressure | sample | at 900° C. | conductivity | strength |
| # | (MPa) | (g/cm³) | (g/cm³) | (W/m · K) | (MPa) |
| 1 | 200 | 1.137 | 1.114 | 0.2682 | 67.5 |
| 2 | 200 | 1.132 | 1.103 | 0.2679 | 57.6 |

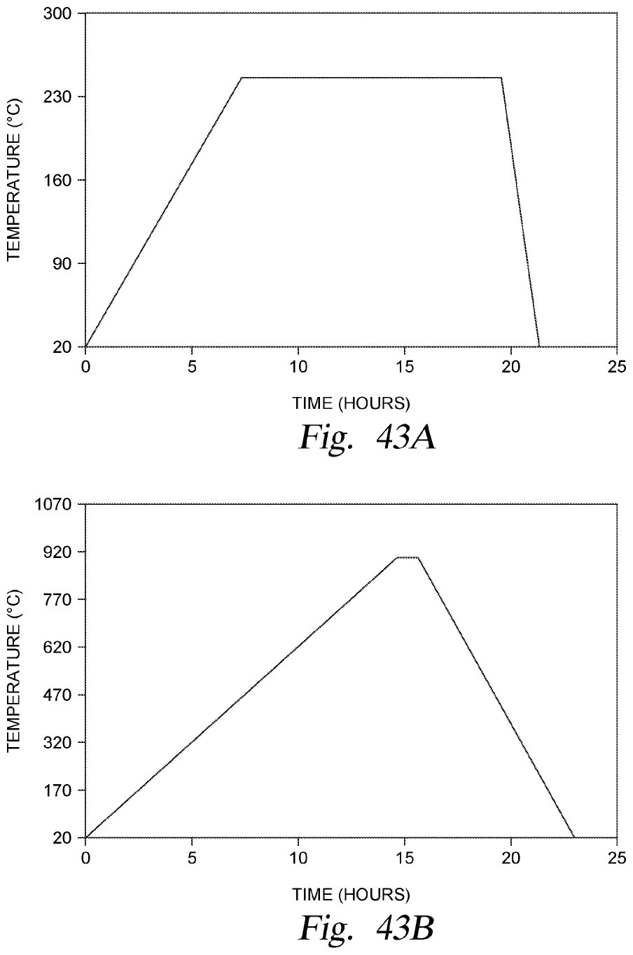

FIG. 43A is a graph illustrating the oxidation process for the CDER material CSUs. FIG. 43B is a graph illustrating the carbonization process for the CDER material CSUs. Table 11 is a summary of the parameters of the oxidation and carbonization of the CDER material CSUs. De and TI are used as binders for the fabrication of CSU with PC. The CSUs are prepared with De, TI, and MP (coal). The CSUs are prepared both with and without heat-treatment. The heat-treatment is done at 430° C. and 450° C. at a rate of 1° C./min and held at the specified temperature for 10 hours in an argon atmosphere maintained with a flow rate of 100 ml/min. The CSUs are prepared at 100 MPa pressing pressure and oxidized at 245° C., followed by carbonization at 900° C. The oxidation temperature at 245° C. avoids breakage of CSUs (De+MP+PC) at 290° C. The mixing ratio by weight maintained as CDER:MP:PC=1:1:4.

TABLE 11
Summary of the Parameters of the Oxidation and
Carbonization of the CDER Material CSUs.

| Parameters | Cross-Linking/Oxidation | Carbonization |
|---|---|---|
| Environment | Air | N₂ |
| Flow rate (ml/min) | 22 | 60 |
| Heating | +0.5° C./min, from 20° C. to | +1° C./min, from 20° C. to |
| | 245° C., 7 hours 30 minutes. | 900° C., 14 hours 40 minutes. |
| Isothermal/hold | 245° C., 12 hours | 900° C., 1 hour |
| Cooling | −2° C./min, from 245° C. to | −2° C./min, from 900° C. to |
| | 20° C., 1 hour 53 minutes. | 20° C., 7 hours 20 minutes. |
| Total test duration | About 22 hours | About 23 hours |

Table 12 is a summary of the mass and dimensions of the CDER CSUs before and after oxidation and carbonization. Table 13 is a summary of the composition of the CDER CSUs. The CDER CSUs include a 430° C. heat-treated De-CSU having a De:PC mass ratio of 1:2 (De430:PC=1:2); an untreated TI-CSU having a TI:PC mass ratio of 1:2 (TI:PC=1:2); a 430° C. heat-treated TI-CSU having a TI:PC mass ratio of 1:2 (TI430:PC=1:2); an untreated DE-CSU with a De:MP:PC mass ratio of 1:1:4 (De:MP:PC=1:1:4); an untreated TI-CSU having a TI:MP:PC mass ratio of 1:1:4 (TI:MP:PC=1:1:4); a 430° C. heat-treated De-CSU having a De430:MP:PC mass ratio of 1:1:4 (De430:MP:PC=1:1:4); a 450° C. heat-treated De-CSU having a De450:MP:PC mass ratio of 1:1:4 (De450:MP:PC=1:1:4); and a 450° C. heat-treated TI-CSU having a TI450:MP:PC mass ratio of 1:1:4 (De430:MP:PC=1:1:4). After oxidation and carbonization the mass changes due to the evaporation of volatile materials, causing shrinkage in dimensions.

TABLE 12
Summary of the Mass and Dimensions of the CDER CSUs.

| | | Before Oxidation & | | | After Oxidation & | | |
|---|---|---|---|---|---|---|---|
| | | Carbonization | | | Carbonization | | |
| | | Mass | Height | Diameter | Mass | Height | Diameter |
| Batch | Sample | (g) | (mm) | (mm) | (g) | (mm) | (mm) |
| De + MP + | 1* | 1.8756 | 10.7 | 15.2 | — | — | — |
| PC | 2 | 2.1738 | 12.1 | 15.2 | 1.4052 | 10.8 | 13.2 |
| | 3 | 2.0961 | 11.5 | 15.1 | 1.5944 | 10.8 | 13.8 |
| TI + MP + | 1 | 2.1806 | 10.6 | 15.1 | 1.4800 | 9.7 | 13.3 |
| PC | 2** | 2.1172 | 10.4 | 15.1 | 1.4156 | 9.2 | 13.3 |
| | 3 | 2.0758 | 9.7 | 15.1 | 1.3655 | 8.0 | 13.8 |
| De430 + | 1 | 1.8756 | 10.7 | 15.2 | 1.3126 | 9.7 | 13.3 |
| MP + PC | 2 | 2.0190 | 11.7 | 15.3 | 1.3740 | 10.4 | 13.3 |
| | 3 | 2.0557 | 11.7 | 15.0 | 1.5937 | 11.0 | 13.9 |
| De450 + | 1 | 2.1967 | 12.9 | 15.1 | 1.5732 | 11.5 | 13.4 |
| MP + PC | 2** | 2.0742 | 12.0 | 15.2 | 1.4497 | 10.8 | 13.3 |
| | 3 | 2.2218 | 12.8 | 15.1 | 1.4576 | 10.3 | 13.8 |
| TI450 + | 1 | 2.2090 | 10.7 | 15.1 | 1.5545 | 9.7 | 13.3 |
| MP + PC | 2 | 2.0922 | 10.4 | 15.2 | 1.4362 | 9.3 | 13.2 |
| | 3 | 2.2041 | 10.8 | 15.1 | 1.7062 | 10.0 | 13.7 |

After oxidation and carbonization, the CSUs are tested for the compressive strength and thermal conductivity. The CSUs having De and TI as the only binder (De430:PC, TI430:PC and TI:PC) exhibit compressive strengths lower than 30 MPa. When De and TI are included in the MP to PC ratio of 1:4 in the preparation of CSUs, the compressive strengths exceeds 30 MPa, except for the De430:MP:PC with the compressive strength of 27.73 MPa. The overall carbon content after preparation and before oxidation and carbonization is greater than 70% for all CSUs. The thermal conductivity of CSUs ranges from 0.175 to 0.226 W/m·K, which is significantly lower than that of concrete (1.7 W/m·K). The density ranges from 0.89 to 1.14 g/cm³, supporting the use of CSU as a building material to reduce the self-weight of a structure.

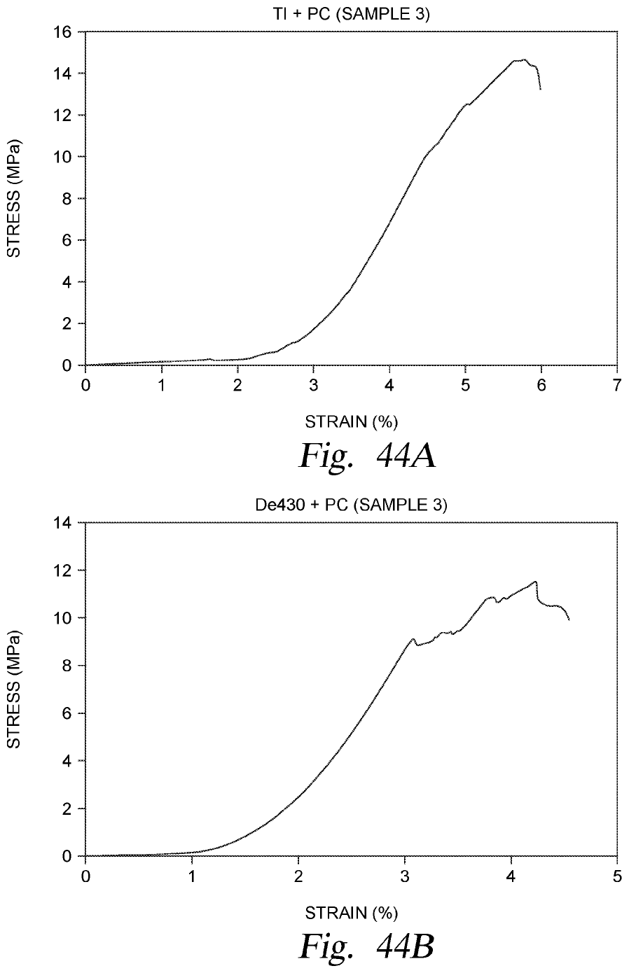

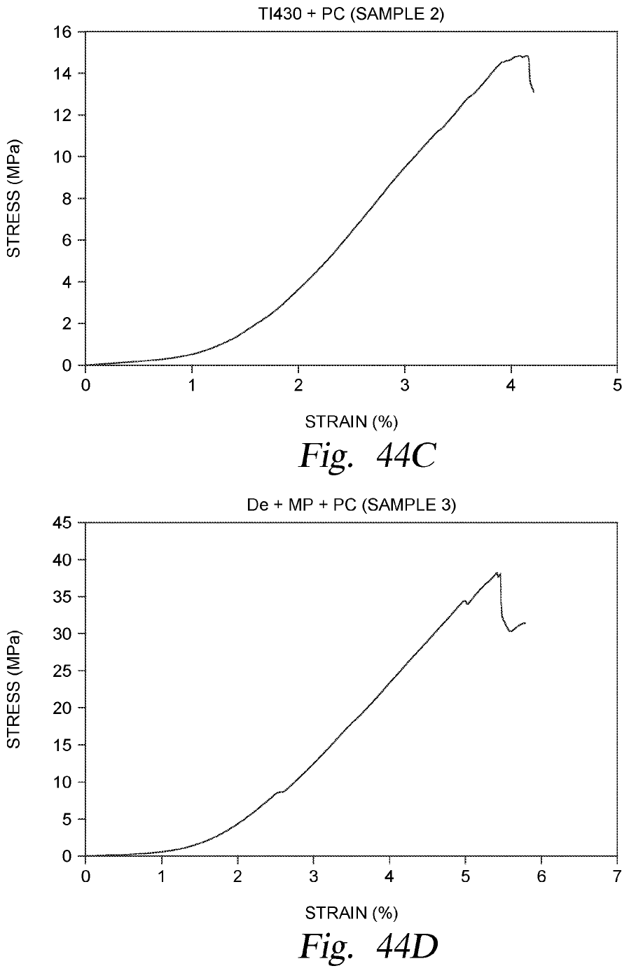

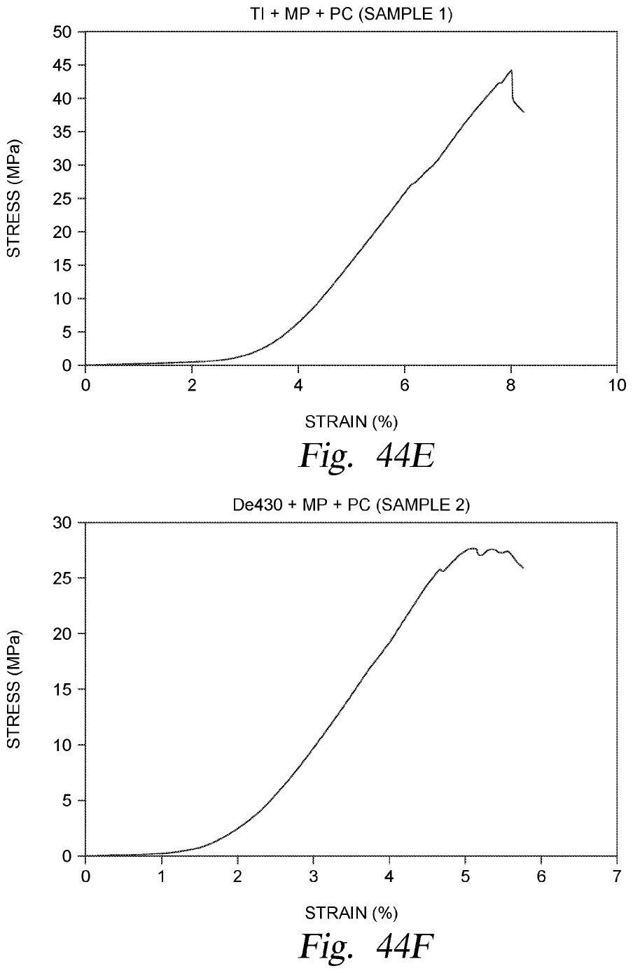

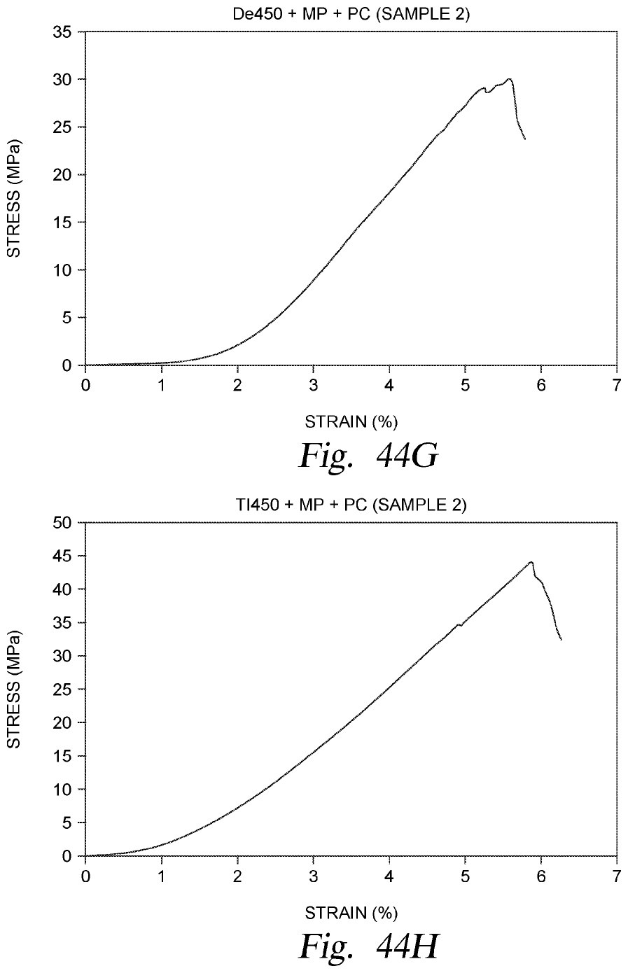

FIG. 44A is a graph illustrating the stress-strain relationship of the TI+PC CSU. FIG. 44B is a graph illustrating the stress-strain relationship of the De430+PC CSU. FIG. 44C is a graph illustrating the stress-strain relationship of the TI430+PC CSU. FIG. 44D is a graph illustrating the stress-strain relationship of the De+MP+PC CSU. FIG. 44E is a graph illustrating the stress-strain relationship of the TI+MP+PC CSU. FIG. 44F is a graph illustrating the stress-strain relationship of the De430+MP+PC CSU. FIG. 44G is a graph illustrating the stress-strain relationship of the De450+MP+PC CSU. FIG. 44H is a graph illustrating the stress-strain relationship of the TI450+MP+PC CSU. The axial stress-strain relationships of the CSUs show that the CSUs exhibit higher initial axial strain (or deformation) at a minimal applied stress. This initial strain may be the closure of preexisting micro-cracks that are created during oxidation and carbonization. Alternatively, the initial strain may be due to the initial deformation of uneven top sample surface. As the strain reaches around 2%, higher stress is mobilized and higher stiffness is observed for the CSUs. A higher pressing pressure (>100 MPa) during manufacturing and an initial setting pressure (around 4-5% of sample strength) during the compression testing may be applied to reduce the high initial strain.

TABLE 13
Summary of the Composition of the CDER CSUs.

| | | Density | | | | |
|---|---|---|---|---|---|---|
| | Carbon | before | Density after | Thermal | Compressive | Elastic |
| | content | oxidation | carbonization | conductivity | strength | modulus |
| Batch | (w/w %) | (g/cm³) | (g/cm³) | (W/m · K) | (MPa) | (MPa) |
| TI:PC = 1:2 | 83.04 | 0.91 | 0.91 | 0.221 | 14.66 | 648 |
| De430:PC = 1:2 | 80.99 | 0.89 | 0.90 | 0.207 | 11.53 | 613 |
| TI430:PC = 1:2 | 74.78 | 0.94 | 0.93 | 0.195 | 14.87 | 513 |
| De:MP:PC = 1:1:4 | 81.10 | 1.02 | 0.99 | 0.207 | 38.21 | 1081 |
| TI:MP:PC = 1:1:4 | 80.70 | 1.14 | 1.11 | 0.186 | 44.40 | 1060 |
| De430:MP:PC = 1:1:4 | 82.01 | 0.94 | 0.94 | 0.175 | 27.73 | 970 |
| De450:MP:PC = 1:1:4 | 82.32 | 0.95 | 0.95 | 0.177 | 30.11 | 926 |
| TI450:MP:PC = 1:1:4 | 78.39 | 1.11 | 1.11 | 0.226 | 44.11 | 846 |

Table 14 is a summary of the mass and dimensions of the P&H treated CDER CSUs. Table 15 is a summary of the composition of P&H treated CDER CSUs. The P&H treated CSUs include a first and a second P&H De-CSU (DE_{P&H}+MP+PC) and a first and second P&H TI-CSU (TI_{P&H}+MP+PC). The CSUs are prepared with P&H-treated De and TI and tested for their compressive strengths. The CSUs have a mixing ratio by weight of CDER:MP:PC=1:1:4 using 100 MPa pressing pressure.

TABLE 14
Summary of the Mass and Dimensions
of the P&H Treated CDER CSUs.

| | | Before Oxidation & | | | After Oxidation & | | |
|---|---|---|---|---|---|---|---|
| | | Carbonization | | | Carbonization | | |
| | | | | Dia- | | | Dia- |
| | | Mass | Height | meter | Mass | Height | meter |
| Batch | Sample | (g) | (mm) | (mm) | (g) | (mm) | (mm) |
| De_{P&H} + | 1 | 2.280 | 13.7 | 15.2 | 1.515 | 12.6 | 13.9 |
| MP + PC | 2 | 2.305 | 13.8 | 15.2 | 1.596 | 12.5 | 13.8 |
| TI_{P&H} + | 1 | 2.061 | 12.5 | 15.2 | 1.782 | 11.4 | 13.4 |
| MP + PC | 2 | 2.186 | 12.7 | 15.2 | 1.801 | 10.9 | 13.4 |

TABLE 15
Summary of the Composition of the P&H Treated CDER CSUs.

| | Carbon | Density before | Density after | Thermal | Compressive | Elastic |
|---|---|---|---|---|---|---|
| | content | oxidation | carbonization | conductivity | strength | modulus |
| Batch | (w/w %) | (g/cm³) | (g/cm³) | (W/m · K) | (MPa) | (MPa) |
| De:MP:PC = 1:1:4 | 81.40 | 1.02 | 0.99 | 0.207 | 38.21 | 1081 |
| De430:MP:PC = 1:1:4 | 82.01 | 0.94 | 0.94 | 0.175 | 27.73 | 970 |
| De_{P&H}:MP:PC = 1:1:4 | 82.95 | 0.92 | 0.77 | 0.159 | 10.48 | 570 |
| TI:MP:PC = 1:1:4 | 79.24 | 1.14 | 1.11 | 0.186 | 44.40 | 1060 |
| TI430:MP:PC = 1:1:4 | 79.60 | 0.97 | 0.95 | 0.176 | 17.92 | 740 |
| TI_{P&H}:MP:PC = 1:1:4 | 80.70 | 0.93 | 0.93 | 0.257 | 15.28 | 735 |

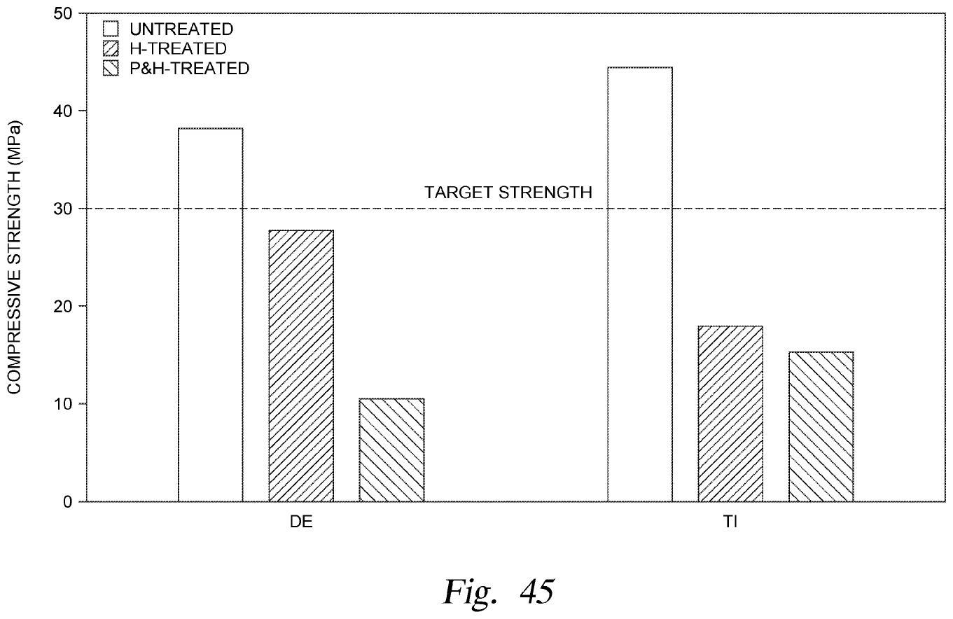

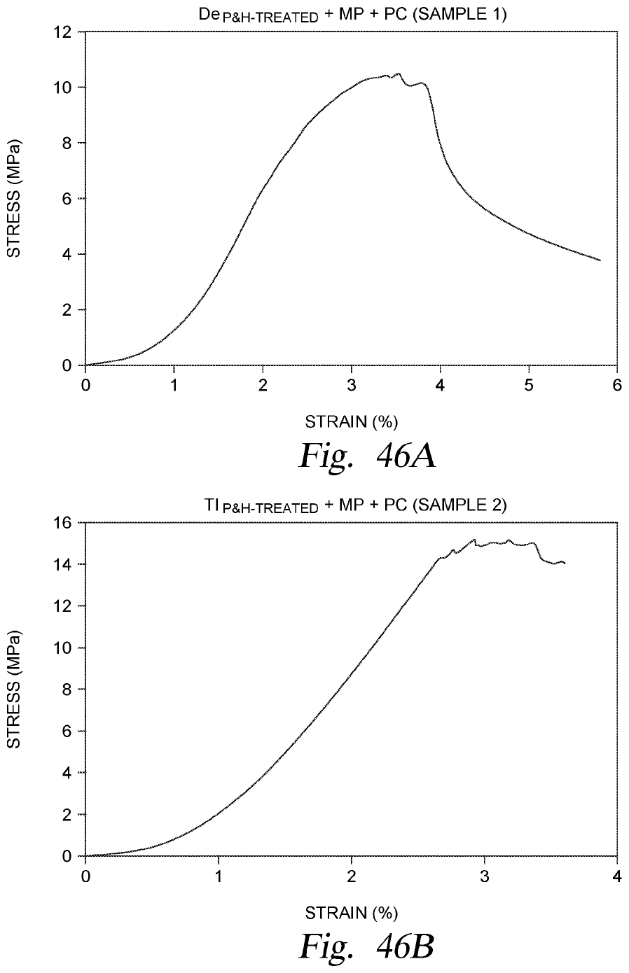

FIG. 45 is a graph illustrating the compressive strength of the CDER CSUs. FIG. 46A is a graph illustrating the stress-strain curve of the DE_{P&H}+MP+PC CSU. FIG. 46B is a graph illustrating the stress-strain curve of the TI_{P&H}+MP+PC CSU. Heat treatment decreases the compressive strength (from 38.2 MPa to 27.7 MPa for De and 44.4 MPa to 17.9 MPa for TI) and P&H-treatment further reduces the compressive strength for both De and TI. Similar decreasing trend is observed on elastic modulus resulted from heat-and P&H-treatments. The axial stress-strain relationships of the CSUs indicate that the CSUs exhibit higher initial axial strain (or deformation) at minimal applied stress.

Table 16 is a summary of the mass and dimensions of the increased CDER material content CSUs. Table 17 is a summary of the composition of the increased CDER material content CSUs. The increased CDER material content CSUs include a first and second De-CSU (DE:MP:PC (1.5:1:5)); and a first and second TI-CSU (TI:MP:PC (1.5:1:5)). The CSUs are prepared with increased CDER material content to optimize CDER material content for two different pressing pressures (100 MPa & 200 MPa). These CSUs have a mixing ratio of CDER:MP:PC=1.5:1:5, maintaining a total binder (1.5+1=2.5) to char (5) ratio of 1:2. The thermal conductivity of CSUs ranges from 0.175 to 0.192 W/m·K and the density ranges from 0.98 to 1.08 g/cm³.

TABLE 16
Summary of the Mass and Dimensions of the Increased CDER Material Content CSUs.

| | | | Before Oxidation & | | | After Oxidation & | | |
|---|---|---|---|---|---|---|---|---|
| | Pressing | | Carbonization | | | Carbonization | | |
| | Pressure | | Mass | Height | Diameter | Mass | Height | Diameter |
| Batch | MPa | Sample | (g) | (mm) | (mm) | (g) | (mm) | (mm) |
| DE:MP:PC | 100 | 1 | 1.8901 | 10.6 | 15.2 | 1.3671 | 9.8 | 13.8 |
| (1.5:1:5) | | 2 | 1.8751 | 10.3 | 15.2 | 1.3962 | 9.6 | 14.0 |
| | 200 | 1 | 1.9765 | 10.5 | 15.2 | 1.4290 | 9.8 | 13.9 |
| | | 2 | 1.9788 | 10.5 | 15.2 | 1.4771 | 9.9 | 14.0 |
| TI:MP:PC | 100 | 1 | 1.8611 | 10.5 | 15.3 | 1.2250 | 9.3 | 13.5 |
| (1.5:1:5) | | 2 | 2.0453 | 11.3 | 15.2 | 1.3287 | 10.0 | 13.5 |
| | 200 | 1 | 1.9987 | 10.3 | 15.3 | 1.3096 | 9.0 | 13.5 |
| | | 2 | 2.1207 | 10.6 | 15.3 | 1.3794 | 9.4 | 13.5 |

TABLE 17
Summary of the Composition of the Increased CDER Material Content CSUs.

| | Carbon | Density before | Density after | Thermal | Compressive | Elastic |
|---|---|---|---|---|---|---|
| | content | oxidation | carbonization | conductivity | strength | modulus |
| Batch | (w/w %) | (g/cm³) | (g/cm³) | (W/m · K) | (MPa) | (MPa) |
| DE:MP:PC = 1.5:1:5_100 | 81.55 | 0.99 | 0.94 | 0.175 | 18.5 | 310 |
| DE:MP:PC = 1.5:1:5_200 | | 1.04 | 0.97 | 0.163 | 21.7 | 375 |
| TI:MP:PC = 1.5:1:5_100 | 78.55 | 0.98 | 1.06 | 0.186 | 17.86 | 615 |
| TI:MP:PC = 1.5:1:5_200 | | 1.08 | 1.10 | 0.192 | 34.36 | 840 |

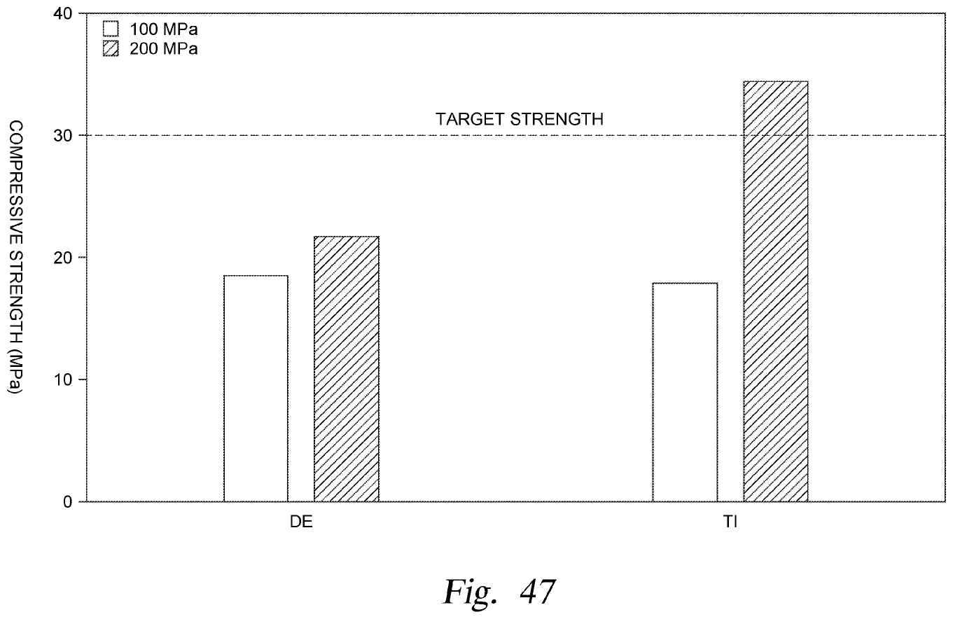

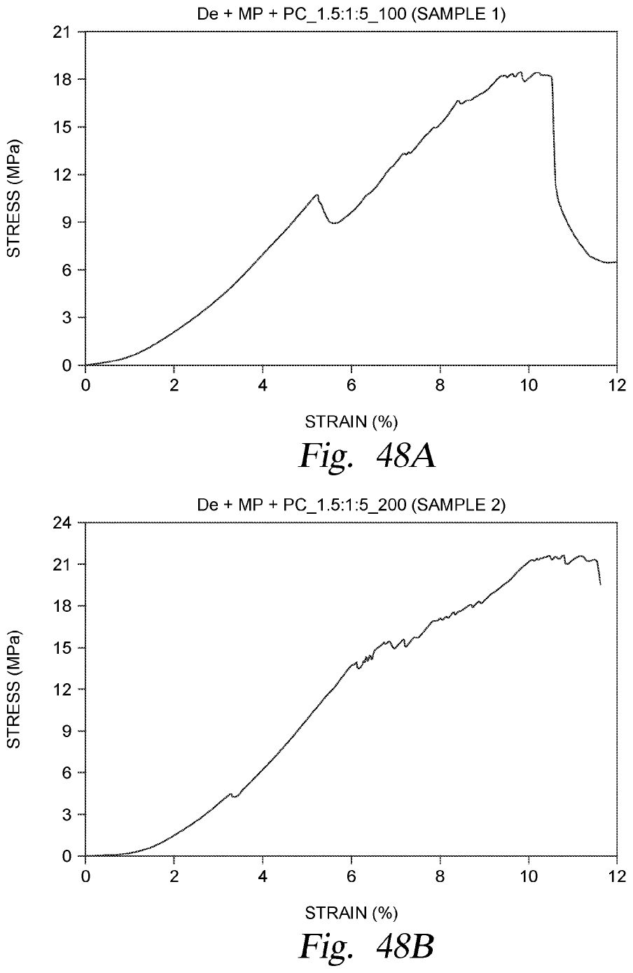

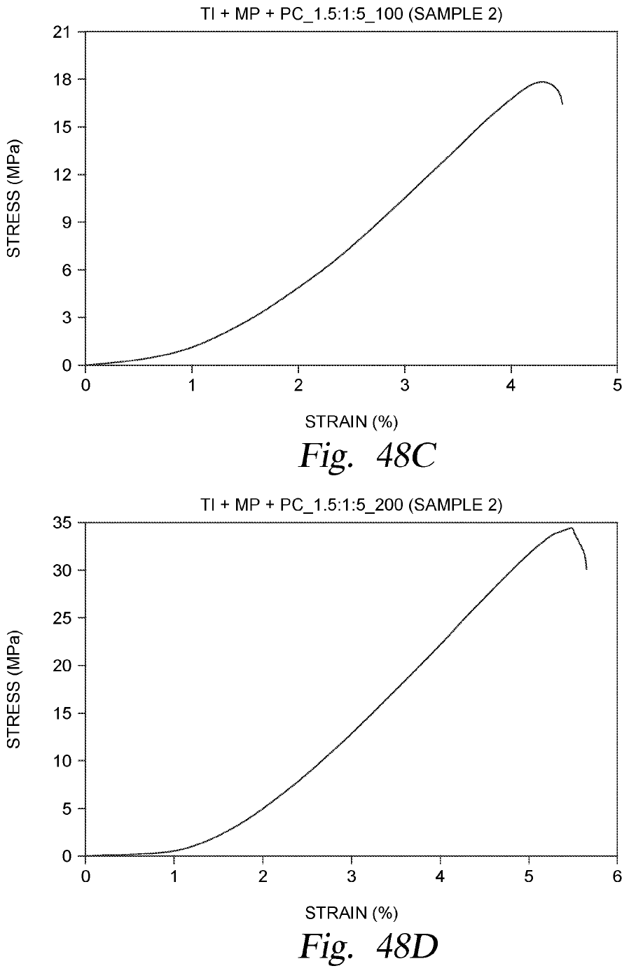

FIG. 47 is a graph illustrating the compressive strength the increased CDER material content CSUs. FIG. 48A is a graph illustrating the stress-strain curve of the first De-CSU. FIG. 48B is a graph illustrating the stress-strain curve of the second De-CSU. FIG. 48C is a graph illustrating the stress-strain curve of the first TI-CSU. FIG. 48D is a graph illustrating the stress-strain curve of the second TI-CSU. Except for TI pressed with 200 MPa, other three batches had the compressive strength lower than 30 MPa. The comparison indicates that the increase in De or TI content reduces the compressive strength and the elastic modulus and slightly decreases the density.

A steel mold may be used to fabricate the CSUs. The steel mold has dimensions of about 25 mm×about 25 mm×about 100 mm to form rectangular CSUs. MP (coal) is mixed with PC at a mixing ratio by weight of about MP: PC=1:2 for flexural testing. A ball mill machine is used to grind a large quantity of about 2 kg of PC to obtain particle sizes less than 40 μm (#400 sieve). About 10 mm and about 20 mm stainless steel balls are placed inside a drum during the grinding process. The ball milling is conducted for 24 hours at a speed of 50 rpm in one directional rotation. After grinding, the PC is sieved using a #400 sieve. More than 99% of the PC passed through the sieve. About 300 g of manually ground MP is ball-milled with about 600 g of PC to mix about evenly for about 24 hours at a speed of about 50 rpm to form a CSU mixture. The CSU mixture is oven-dried at a temperature of 150° C. for 24 hours before storing it in an air-tight container.

Table 18 is a summary of the physical properties of the CSU. About 75 grams of the CSU mixture is used to fabricate each CSU with a pressing pressure of about 100 MPa for about 10 minutes. A 50-ton capacity pressing equipment is used to apply the pressure on the CSU mixture. The filling heights from opposite sides are checked before pressing to make sure uniform compression throughout the length of the sample. The mold is placed under the center of the pressing piston to complete the pressing.

TABLE 18
Summary of Physical Properties of the CSU.

| | Oxidation and | Mass, | Length, | Width, | Height, | Volume, | Density, |
|---|---|---|---|---|---|---|---|
| Sample | carbonization | gm | mm | mm | mm | cm³ | gm/cm³ |
| 1 | Before | 74.8 | 102.6 | 25.2 | 26.0 | 67.22 | 1.11 |
| | After | 64.35 | 95.5 | 23.6 | 24.7 | 55.67 | 1.16 |
| 2 | Before | 74.7 | 102.6 | 25.2 | 25.9 | 66.96 | 1.12 |
| | After | 62.92 | 95.5 | 23.5 | 24.5 | 54.98 | 1.14 |
| 3 | Before | 75.50 | 102.6 | 25.2 | 26.0 | 67.22 | 1.12 |
| | After | 62.69 | 95.1 | 23.3 | 24.5 | 54.29 | 1.15 |

The gas connection for the tube furnace was setup for oxidation and carbonization. An oxidation stabilization process is conducted by heating the CSU to about 245° C. in an air environment at a rate of about 0.5° C./min. The CSU is held at temperature for about 12 hours. The CSU is cooled down to room temperature of about 25° C. at a rate of about 2° C./min. A carbonization process is conducted by heating the CSU to about 900° C. under nitrogen flow at a heating rate of about 1° C./min. The temperature is held for about 1 hour and cooled down at a cooling rate of about 2° C./min. The average densities before and after oxidation and carbonization are about 1.11 gm/cm³ and about 1.15 gm/cm³, respectively, which is much lower than a typical concrete density of 2.8 g/cm³.

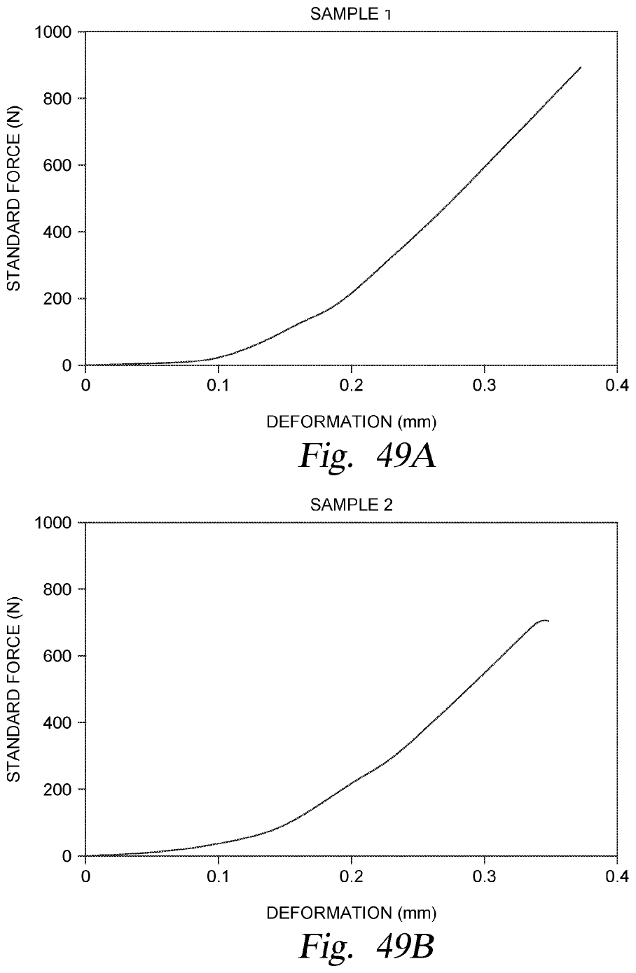

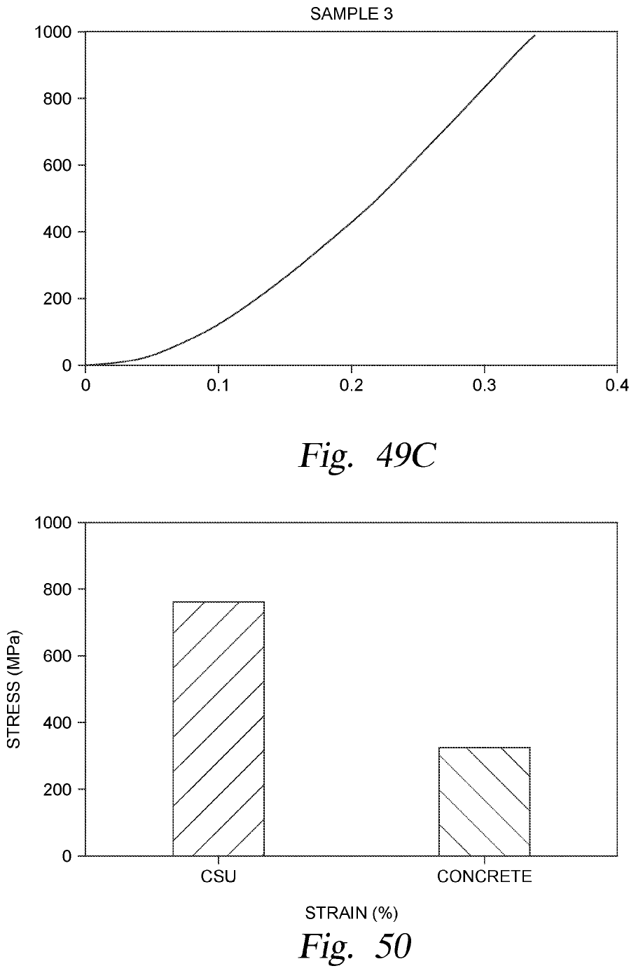

FIG. 49A is a graph illustrating the flexural strength of a CSU sample 1. FIG. 49B is a graph illustrating the flexural strength of a CSU sample 2. FIG. 49C is a graph illustrating the flexural strength of a CSU sample 3. FIG. 50 is a graph illustrating the modulus of rupture for CSU and concrete. A 20-kN load cell with an extensometer is used with a loading rate of 200 N/min. The average modulus of rupture of the CSU samples is about 4.62 MPa, which is about 50% higher than a typical modulus of rupture 3.01 MPa of concrete.

Table 19 shows the physical properties of the cylindrical CSU samples before oxidation and carbonization. Table 20 shows the physical properties of the cylindrical CSU samples after oxidation and carbonization. Cylindrical CSU samples are fabricated using MP and PC with a mass ratio of 1:2. A steel mold is used under about 100 MPa pressing pressure for 10 minutes. The oxidation stabilization process is conducted by heating the compacted sample to about 245° C. in an air environment at a rate of 0.5° C./min. The mixture is held at temperature for about 12 hours before cooling it down to room temperature of about 25° C. at a rate of about 2° C./min. The carbonization process is conducted by heating the samples to about 900° C. under nitrogen flow at a heating rate of about 1° C./min. The temperature is held for about 1 hour and cooled down at a cooling rate of about 2° C./min. The average density after compression is 1.15 gm/cm³, and the average density after oxidation stabilization and carbonization is 1.17 gm/cm³.

TABLE 19
Physical Properties of Cylindrical CSU Samples
Before Oxidation and Carbonization.

| | Mass, | Diameter, | Thickness, | Thickness-to- | Density |
|---|---|---|---|---|---|
| Sample | gm | mm | mm | diameter ratio | (g/cm³) |
| 1 | 2.067 | 15.1 | 10.1 | 0.67 | 1.14 |
| 2 | 3.135 | 15.1 | 15.6 | 1.03 | 1.12 |
| 3 | 3.799 | 15.1 | 18.8 | 1.25 | 1.13 |
| 4 | 1.707 | 15.1 | 8.2 | 0.54 | 1.16 |
| 5 | 2.029 | 15.1 | 9.6 | 0.64 | 1.18 |
| 6 | 1.566 | 15.1 | 7.6 | 0.50 | 1.15 |

TABLE 20
Physical Properties of Cylindrical CSU Samples
After Oxidation and Carbonization.

| | Mass, | Diameter, | Thickness, | Thickness-to- | Density |
|---|---|---|---|---|---|
| Sample | gm | mm | mm | diameter ratio | (g/cm³) |
| 1 | 1.666 | 13.9 | 9.4 | 0.68 | 1.17 |
| 2 | 2.513 | 13.9 | 14.5 | 1.04 | 1.14 |
| 3 | 3.065 | 13.9 | 17.5 | 1.26 | 1.15 |
| 4 | 1.365 | 13.9 | 7.6 | 0.55 | 1.18 |
| 5 | 1.648 | 13.9 | 9.0 | 0.65 | 1.21 |
| 6 | 1.279 | 13.9 | 7.1 | 0.51 | 1.19 |

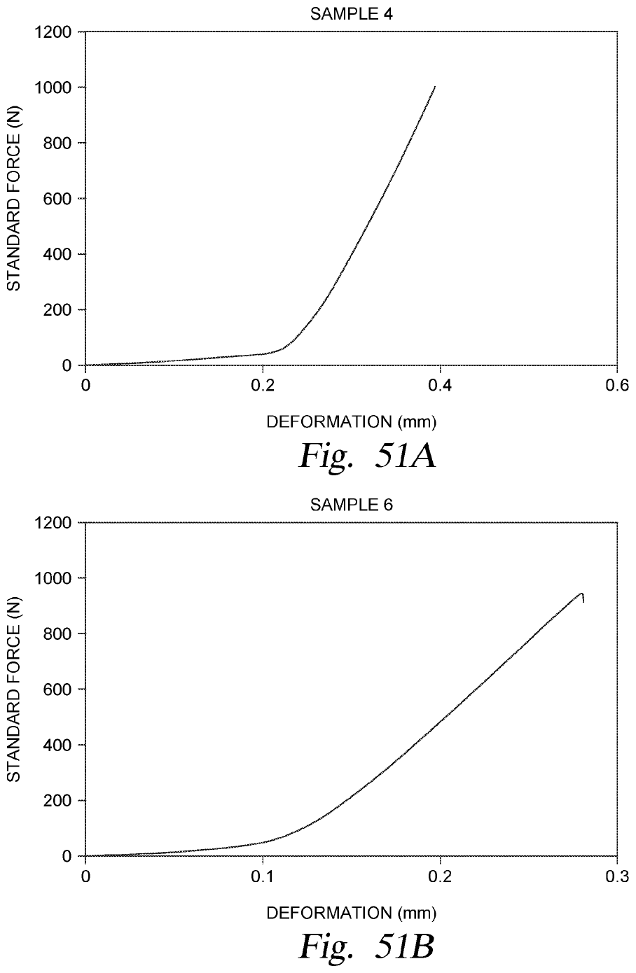

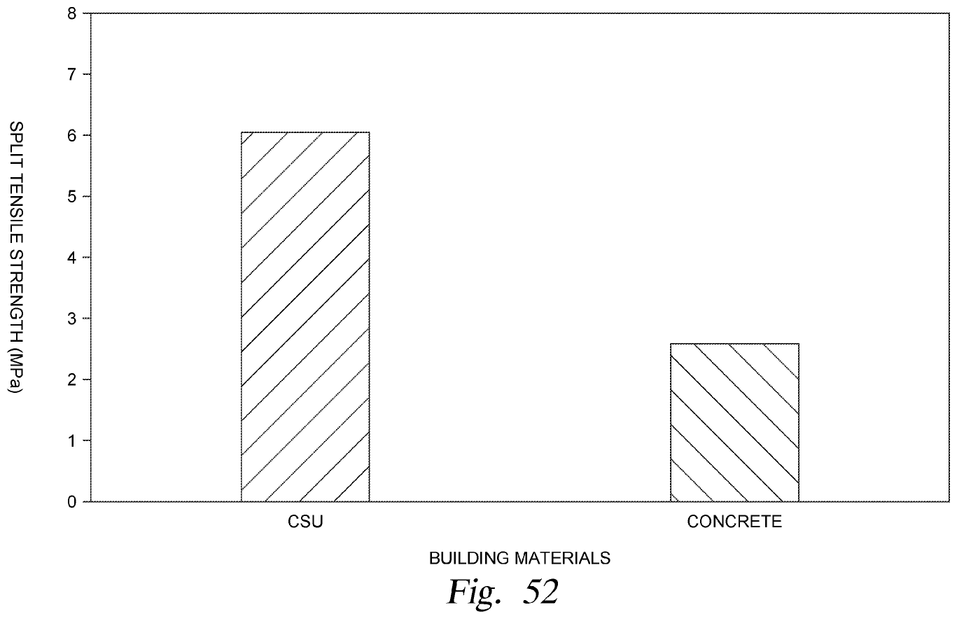

FIG. 51A is a graph illustrating the load v. deformation curve of CSU sample 4. FIG. 51B is a graph illustrating the load v. deformation curve of CSU sample 6. FIG. 52 is a graph illustrating the compressive strength of CSU and concrete. Two CSU samples (Samples 4 and 6) with thickness to diameter ratio of about 0.50 are tested. The average split tensile strength of the CSU samples is 6.07 MPa, which is about 235% higher than the typical split tensile strength 2.58 MPa of normal concrete.

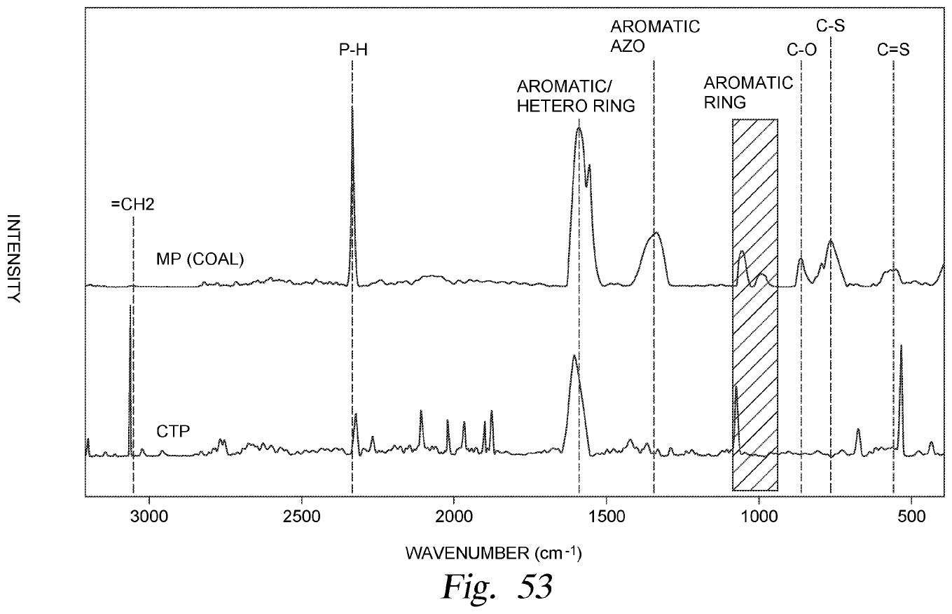

FIG. 53 is a graph illustrating the Raman shift of MP (coal) and CTP. The shape and shift of the Raman peak of organic materials reveal the atomic and molecular level vibration information of the aromatic ring structure. The MP (coal) has higher peak intensity than CTP for the functional groups of C—S at about 770 cm⁻¹, C—O at about 805 cm⁻¹, aromatic azo at about 1365 cm⁻¹, and P—H at about 2330 cm⁻¹. CTP has higher peak intensity than MP (coal) for the functional groups of C═S at about 575 cm⁻¹, alkyne at about 2100 cm⁻¹, and ═CH₂ at about 3050 cm⁻¹. The higher major aromatic peaks of MP between about 800 cm⁻¹ to about 1100 cm⁻¹ and at about 1590 cm⁻¹ indicate that MP (coal) has higher aromaticity than CTP. The Raman result agrees with that from the FTIR analysis. Hence, MP may be expected to perform better as a binder than CTP in the manufacturing and performance of CSU.

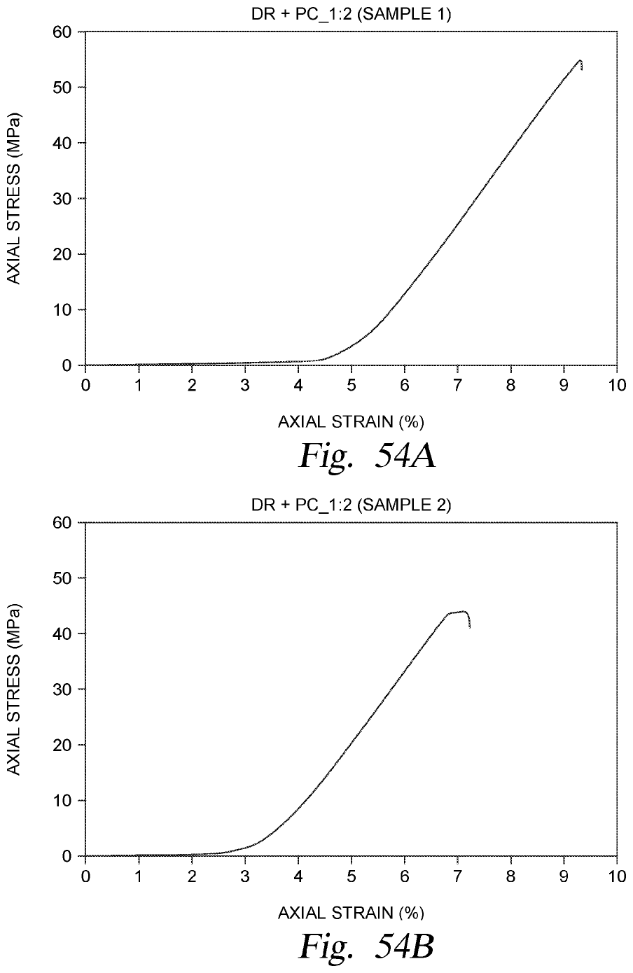

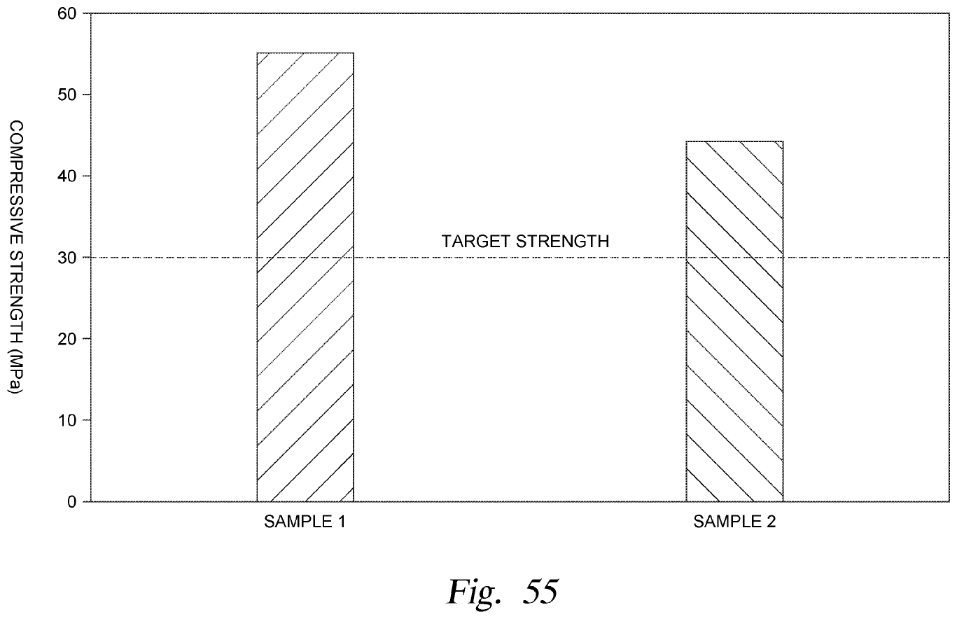

Table 21 shows the physical properties of CSU samples. FIG. 54A is a graph illustrating the stress/strain curve of a first CSU sample. FIG. 54B is a graph illustrating the stress/strain curve of a second CSU sample. FIG. 55 is a graph illustrating the compressive strength of a first CSU sample and the second CSU sample. The DR is used with PC to fabricate the CSU samples to evaluate the binding performance of DR based on compressive strength. Three CSU samples are prepared with a mixing ratio of DR:PC=1:2 by weight. The average densities are 1.10 gm/cm³ and 1.00 gm/cm³ before and after oxidation and carbonization, respectively. The average measured thermal conductivity is 0.154 W/m·K. The compressive strength of about 49.45 MPa for the CSU samples using DR is higher than the target compressive strength of 30 MPa, indicating the DR may be a useful as a binder material.

TABLE 21
Physical Properties of CSU Samples.

| | Oxidation and | | Diameter, | Thickness, | Volume, | Density, |
|---|---|---|---|---|---|---|
| Sample | carbonization | Mass, gm | mm | mm | cm³ | gm/cm³ |
| 1 | Before | 2.13 | 10.8 | 15.1 | 1.93 | 1.10 |
| | After | 1.34 | 9.6 | 13.3 | 1.33 | 1.00 |
| 2 | Before | 2.13 | 10.8 | 15.1 | 1.93 | 1.10 |
| | After | 1.33 | 9.6 | 13.3 | 1.33 | 1.00 |
| 3 | Before | 2.11 | 10.6 | 15.1 | 1.90 | 1.11 |
| | After | 1.32 | 9.5 | 13.3 | 1.32 | 1.00 |

### EMBODIMENTS LISTING

The present disclosure provides, among other things, the following embodiments, each of which can be considered as optionally including any alternate embodiment.

Clause 1. A composition, comprising:
about 1% to about 80% pyrolysis char (PC);
about 0.1% to about 35% coal deposits, extracts, and residual tar (CDER) materials; and
about 0% to about 99% pitch material.

Clause 2. The composition of clause 1, wherein the CDER material comprises a tetralin insoluble (TI), a deposit (De), a distillation residue (DR), a residue (Re), or combinations thereof.

Clause 3. The composition of clause 1, wherein the pitch material comprises a mesophase pitch from coal (MP (coal)) a mesophase pitch from naphthalene (MP (naphthalene)), a coal tar pitch, or combinations thereof.

Clause 4. The composition of clause 1, wherein the PC is pyrolyzed between about 600° C. and about 900° C.

Clause 5. The composition of clause 1, wherein the grain size of the PC is about 0.05 mm to about 1.0 mm, such as about 0.25 mm to about 0.5 mm.

Clause 6. The composition of clause 2, wherein the porosity of the PC is about 0.01% to about 0.025%.

Clause 7. The composition of clause 1, wherein the average pore size of the PC is about 1 nm to about 2 nm.

Clause 8. The composition of clause 1, wherein the specific surface area of the PC is about 200 m²/g to about 300 m²/g.

Clause 9. A carbon-based structural unit (CSU), comprising:
a cured composition, the composition comprising:
   about 1% to about 80% pyrolysis char (PC);
   about 0.1% to about 35% coal deposits, extracts, and residual tar (CDER) materials; and
   about 0% to about 99% pitch material.

Clause 10. The CSU of clause 9, wherein the CDER material comprises a tetralin insoluble (TI), a deposit (De), a distillation residue (DR), a residue (Re), or combinations thereof.

Clause 11. The CSU of clause 9, wherein the pitch material comprises a mesophase pitch from coal (MP (coal)) a mesophase pitch from naphthalene (MP (naphthalene)), a coal tar pitch, or combinations thereof.

Clause 12. The CSU of clause 9, wherein the PC is pyrolyzed between about 600° C. and about 900° C.

Clause 13. The CSU of clause 9, wherein the grain size of the PC is about 0.05 mm to about 1.0 mm, such as about 0.25 mm to about 0.5 mm.

Clause 14. The CSU of clause 13, wherein the porosity of the PC is about 0.01% to about 0.025%.

Clause 15. The CSU of clause 9, wherein the average pore size of the PC is about 1 nm to about 2 nm.

Clause 16. The CSU of clause 9, wherein the specific surface area of the PC is about 200 m²/g to about 300 m²/g.

Clause 17. The CSU of clause 9, wherein the CSU has a compressive strength of about 10 MPa to about 120 MPa.

Clause 18. The CSU of clause 9, wherein the CSU has an average density of the CSUs is from about 0.5 g/cm³ 1.5 g/cm³.

Clause 19. The CSU of clause 9, wherein the CSU has a thermal conductivity from about 0.1 W/m·K to about 0.5 W/m·K.

Clause 20. A method of making a composition, comprising:
extracting a coal extraction residue (CER) from coal;
fabricating pyrolysis char (PC) and a coal deposits, extracts, and residual tar (CDER) material from the CER;
sieving and milling the PC into milled PC;
mixing the pyrolysis char (PC) and the CDER material to form a composition, wherein the composition comprises:
   about 1% to about 80% PC;
   about 0.1% to about 35% CDER material.

Clause 21. The method of clause 20, wherein the composition further comprises about 0% to about 99% of a pitch material.

Clause 22. The method of clause 21, wherein the pitch material comprises a mesophase pitch from coal (MP (coal)) a mesophase pitch from naphthalene (MP (naphthalene)), a coal tar pitch, or combinations thereof.

Clause 23. The composition of clause 20, wherein the CDER material comprises a tetralin insoluble (TI), a deposit (De), a distillation residue (DR), a residue (Re), or combinations thereof.

Clause 24. The method of clause 20, wherein the PC is pyrolyzed between about 600° C. and about 900° C.

Clause 25. The method of clause 20, wherein the grain size of the PC is about 0.05 mm to about 1.0 mm, such as about 0.25 mm to about 0.5 mm.

Clause 26. The method of clause 20, wherein the porosity of the PC is about 0.01% to about 0.025%.

Clause 27. The composition of clause 20, wherein the average pore size of the PC is about 1 nm to about 2 nm.

Clause 28. The method of clause 20, wherein the specific surface area of the PC is about 200 m²/g to about 300 m²/g.

Clause 29. The method of clause 20, wherein the milled PC may has a diameter of less than about 35 μm.

Clause 30. The method of clause 20-29, further comprising heat-treating the CDER material to form a heat-treated CDER, wherein the heat-treatment occurs between about 400° C. and 500° C.

Clause 31. The method of clause 20-29, further comprising pressure heat-treating (P&H treating) the CDER material to form a pressure heat-treated (P&H treated) CDER, wherein the P&H treatment occurs between about 400° C. and 500° C. at an applied pressure of about 2 MPa to about 6 MPa.

Clause 32. The method of clause 31, wherein the P&H treatment includes a heating rate is about 2.5° C./min to about 7.5° C./min from room temperature to the P&H treatment temperature.

Clause 33. The method of clause 30-32, further comprising molding the composition to form a CSU.

Clause 34. The method of clause 33, wherein the composition is molded into the CSU under an applied pressure of about 50 MPa to about 500 MPa.

Clause 35. The method of clause 34, further comprising oxidizing the CSU through an oxidation process and carbonizing the CSU through a carbonization process.

Clause 36. The method of clause 35, wherein the oxidation process comprises:
heating the CSU to a temperature of about 200° C. to about 300° C. in an air atmosphere at a rate of 0.5° C./min to about 1.5° C./min; and
holding the CSU at the temperature of about 200° C. to about 300° C. for about 12 hour to about 20 hours.

Clause 37. The method of clause 35 and 36, wherein the carbonization process comprises:
heating the CSU to a temperature of about 600° C. to about 1000° C. at a rate of about 1.5° C./min to about 4.5° C./min in an argon atmosphere; and
holding the CSU at the temperature of 600° C. to about 1000° C. for about 0.5 hours to about 3 hours.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, process operation, process operations, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, process operation, process operations, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

While the foregoing is directed to embodiments of the present disclosure, other and further embodiments of the disclosure may be devised without departing from the basic scope thereof.

What is claimed is:

1. A composition, comprising:
about 1% to about 80% pyrolysis char (PC);
about 0.1% to about 35% coal deposits, extracts, and residual tar (CDER) materials; and
about 0% to about 99% pitch material.

2. The composition of claim 1, wherein the CDER material comprises a tetralin insoluble (TI), a deposit (De), a distillation residue (DR), a residue (Re), or combinations thereof.

3. The composition of claim 1, wherein the pitch material comprises a mesophase pitch from coal (MP (coal)), a mesophase pitch from naphthalene (MP (naphthalene)), a coal tar pitch, or combinations thereof.

4. The composition of claim 1, wherein the PC is pyrolyzed between about 600° C. and about 900° C.

5. A carbon-based structural unit (CSU), comprising:
a cured composition, the cured composition comprising:
about 1% to about 80% pyrolysis char (PC);
about 0.1% to about 35% coal deposits, extracts, and residual tar (CDER) materials; and
about 0% to about 99% pitch material.

6. The CSU of claim 5, wherein the CDER material comprises a tetralin insoluble (TI), a deposit (De), a distillation residue (DR), a residue (Re), or combinations thereof.

7. The CSU of claim 5, wherein the pitch material comprises a mesophase pitch from coal (MP (coal)), a mesophase pitch from naphthalene (MP (naphthalene)), a coal tar pitch, or combinations thereof.

8. The CSU of claim 5, wherein the CSU has a compressive strength of about 10 MPa to about 120 MPa.

9. The CSU of claim 5, wherein the CSU has an average density of the CSUs is from about 0.5 g/cm³ 1.5 g/cm³.

10. The CSU of claim 9, wherein the CSU has a thermal conductivity from about 0.1 W/m·K to about 0.5 W/m·K.

11. The CSU of claim 5, wherein an average pore size of the PC is about 1 nm to about 2 nm.

12. A method of making a composition, comprising:
extracting a coal extraction residue (CER) from coal;
fabricating pyrolysis char (PC) and a coal deposits, extracts, and residual tar (CDER) material from the CER;
sieving and milling the PC into milled PC;
mixing the pyrolysis char (PC) and the CDER material to form a composition, wherein the composition comprises:
about 30% to about 80% PC;
0.1% to about 35% CDER material.

13. The method of claim 12, wherein the composition further comprises about 0% to about 99% of a pitch material.

14. The method of claim 12, further comprising heat-treating the CDER material to form a heat-treated CDER, wherein the heat-treatment occurs between about 400° C. and 500° C.

15. The method of claim 12, further comprising pressure heat-treating (P&H treating) the CDER material to form a pressure heat-treated (P&H treated) CDER, wherein the P&H treatment occurs between about 400° C. and 500° C. at an applied pressure of about 2 MPa to about 6 MPa.
